(19) United States
(12) Patent Application Publication
(10) Pub. No.: US 2026/0222051 A1
(43) Pub. Date: Jul. 30, 2026

(54) UPLINK CHANNEL ACQUISITION

(71) Applicant: Samsung Electronics Co., Ltd., Suwon-si (KR)

(72) Inventors: Dalin Zhu, Allen, TX (US); Eko Onggosanusi, Coppell, TX (US)

(21) Appl. No.: 19/446,832

(22) Filed: Jan. 12, 2026

Related U.S. Application Data
(60) Provisional application No. 63/751,057, filed on Jan. 29, 2025.

(51) Int. Cl. H04B 7/06; H04L 5/00; H04W 72/231; H04W 76/20

(52) U.S. Cl. CPC H04B 7/06968; H04B 7/0626; H04L 5/0051; H04W 72/231; H04W 76/20

(57) ABSTRACT

Apparatuses and methods for uplink channel acquisition. A method performed by a user equipment (UE) includes receiving one or more transmission configuration indication (TCI) states, receiving a first indicator indicating a subset of the one or more TCI states, receiving a second indicator to enable uplink (UL) channel acquisition by the UE, and determining, based on the first indicator, a first TCI state and a second TCI state from the subset. The method further includes identifying a first reference signal (RS) and a second RS associated with the first and second TCI states, respectively, determining, based on the second indicator and measurements of the first and second RSs, UL channel state information (CSI), and transmitting information related to the UL CSI.

### CROSS-REFERENCE TO RELATED AND CLAIM OF PRIORITY

The present application claims priority under 35 U.S.C. § 119(e) to: U.S. Provisional Patent Application No. 63/751,057 filed Jan. 29, 2025, which is hereby incorporated by reference in its entirety.

### TECHNICAL FIELD

The present disclosure relates generally to wireless communication systems and, more specifically, to uplink channel acquisition.

### BACKGROUND

Wireless communication has been one of the most successful innovations in modem history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to uplink channel acquisition.

In one embodiment, a user equipment (UE) is provided. The UE includes a transceiver configured to receive one or more transmission configuration indication (TCI) states, receive a first indicator indicating a subset of the one or more TCI states, and receive a second indicator to enable uplink (UL) channel acquisition by the UE. The UE further includes a processor operably coupled with the transceiver. The processor is configured to determine, based on the first indicator, a first TCI state and a second TCI state from the subset, identify a first reference signal (RS) and a second RS associated with the first and second TCI states, respectively, and determine, based on the second indicator and measurements of the first and second RSs, UL channel state information (CSI). The transceiver is further configured to transmit information related to the UL CSI.

In another embodiment, a base station (BS) is provided. The BS includes a processor and a transceiver operably coupled with the processor. The transceiver is configured to transmit one or more TCI states, transmit a first indicator indicating a subset of the one or more TCI states, transmit a second indicator to enable UL channel acquisition by the UE, and receive information related to a UL CSI. The UL CSI is based on the second indicator, a first RS, and a second RS. The first and second RSs are associated with a first TCI state and a second TCI state from the subset.

In yet another embodiment, a method performed by a UE is provided. The method includes receiving one or more TCI states, receiving a first indicator indicating a subset of the one or more TCI states, receiving a second indicator to enable UL channel acquisition by the UE, and determining, based on the first indicator, a first TCI state and a second TCI state from the subset. The method further includes identifying a first RS and a second RS associated with the first and second TCI states, respectively, determining, based on the second indicator and measurements of the first and second RSs, UL CSI, and transmitting information related to the UL CSI.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example of using a TCI state to indicate a pair of RSs for beam tracking according to embodiments of the present disclosure;

FIG. 8 illustrates an example of configuring or indicating a pair of RSs for beam tracking according to embodiments of the present disclosure;

FIG. 9 illustrates an example of using a lookup table to determine the association/mapping relation between RSs/RS resources for beam tracking according to embodiments of the present disclosure;

FIG. 10 illustrates an example of configuring or indicating a pair of TCI states for beam tracking according to embodiments of the present disclosure;

FIG. 11 illustrates an example of using a TCI state to indicate a group of three RSs for beam tracking according to embodiments of the present disclosure;

FIG. 12 illustrates an example of configuring or indicating a group of three RSs for beam tracking according to embodiments of the present disclosure;

FIG. 13 illustrates an example of configuring or indicating a group of three TCI states for beam tracking according to embodiments of the present disclosure;

FIG. 14 illustrates an example CSI/beam report according to embodiments of the present disclosure;

FIG. 15 illustrates another example CSI/beam report according to embodiments of the present disclosure;

FIG. 16 illustrates an example procedure for UL channel acquisition via DL sum/difference beam RSs according to embodiments of the present disclosure;

FIG. 17 illustrates an example procedure for UEI UL channel acquisition via DL sum/difference beam RSs according to embodiments of the present disclosure; and

FIG. 18 illustrates an example method performed by a UE in a wireless communication system according to embodiments of the present disclosure.

### DETAILED DESCRIPTION

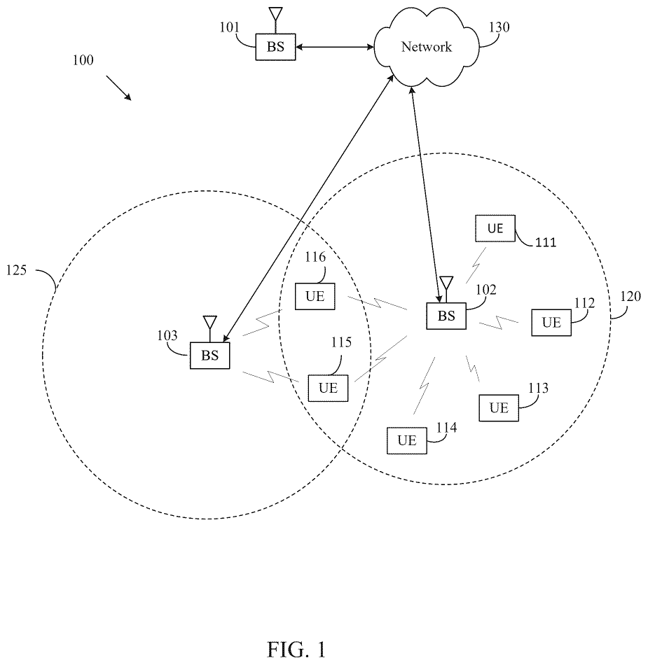

FIGS. 1-18 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1]3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical Layer Procedures for Control;” [REF 4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing UE-initiated/event-driven beam measurement and reporting procedures. In certain embodiments, one or more of the BSs 101-103 include circuitry, programing, or a combination thereof to support UE-initiated/event-driven beam measurement and reporting procedures.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

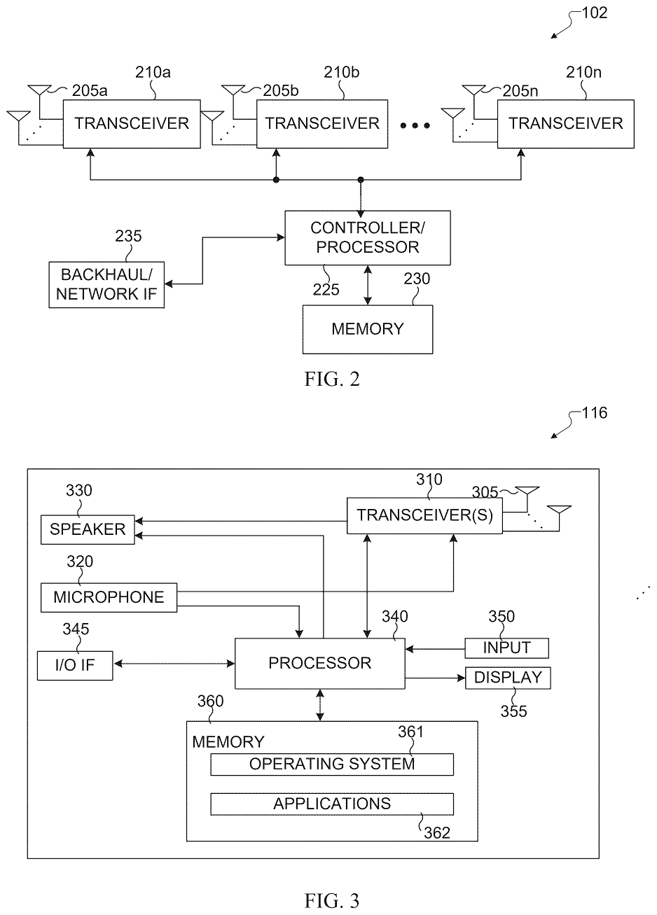

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting UE-initiated/event-driven beam measurement and reporting procedures. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize UE-initiated/event-driven beam measurement and reporting procedures as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

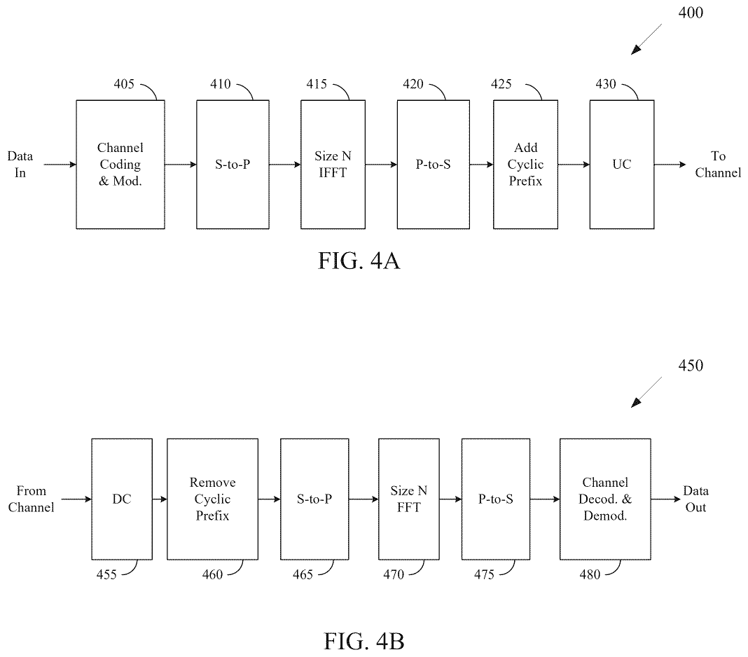

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support UE-initiated/event-driven beam measurement and reporting procedures as described in embodiments of the present disclosure. In some embodiments, the receive path 450 is configured to support UE) reporting triggered beam switching as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

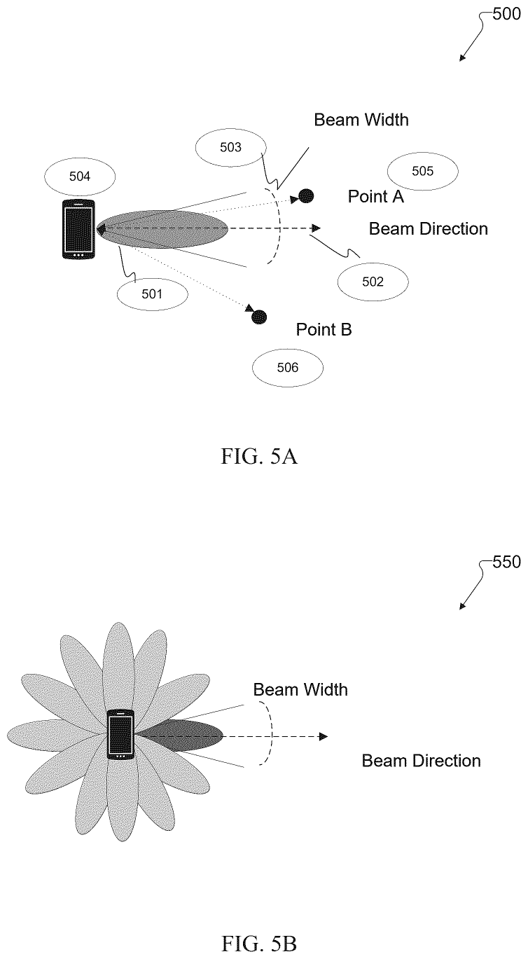

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, abeam is in 2D, it should be apparent to those skilled in the art, that a beam can be 3D, where a beam can be transmitted to or received from any direction in space.

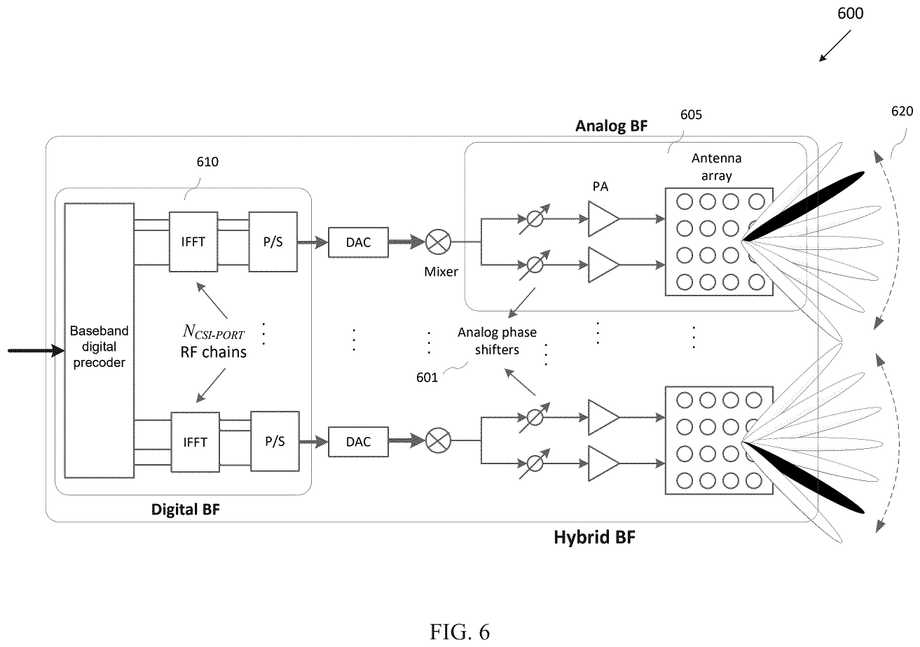

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be vaned across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (~10 dB additional loss per 100 m distance), a larger number and narrower analog beams (hence a larger number of radiators in the array) are needed to compensate for the additional path loss.

In this disclosure, a beam is determined by either of,
A transmission configuration indication (TCI) state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Embodiments of the present disclosure recognize that at mmWave frequencies, or FR2 in the 3GPP NR, one or more analog TX-RX beam pair links (BPLs) are established between the gNB and the UE to transmit/receive the data/control information. To ensure sufficient BPL quality, an exhaustive search of all combinations of TX-RX beams could be performed (also referred to as one-stage beam acquisition design), from which the best TX-RX beam pair(s) could be determined. A large amount of TX-RX beam sweeping/scanning is required though, which could be a source of overhead. Especially with a large number of TCI states and/or when the UE is moving at a high speed, frequent and exhaustive TX-RX beam pairs search would introduce significantly large signaling overhead and access latency, which is undesired for various deployment scenarios and system settings in the 5G NR and future-generation (e.g., 6G) wireless communications systems. Hence, there is a need of efficient yet effective beam management/operation method(s) to reduce the channel acquisition latency and overhead.

Accordingly, in the present disclosure, sum/difference beams based beam management/operation methods are introduced, which can reduce the channel acquisition latency and overhead. This disclosure also provides various signaling alternatives and the corresponding UE's operations to support or enable the provided channel acquisition methods via sum/difference beams based differential beamforming.

In one embodiment, a UE could be configured or provided or indicated by the network, a pair of a first RS or RS resource and a second RS or RS resource, to perform e.g. L1 measurement(s). In one example, the first and second RS or RS resources—e.g., in terms/form their RS/resource IDs/indexes—could be provided or configured in a same higher layer parameter denoted by resourcePair. In another example, the first and second RS or RS resources could be respectively associated with a first and a second TCI states configured, activated or indicated to the UE according to or following those specified herein in the present disclosure.

Method-1: the first RS or RS resource could be referred to as a sum beam having a beam pattern/structure of

$${\frac{1}{\sqrt{{N}_{t}}} [ 1 , … , {e}^{- j ( \frac{{N}_{t}}{2} - 1 ) μ} , {e}^{- j ( \frac{{N}_{t}}{2} ) μ} , … , {e}^{- j ( {N}_{t} - 1 ) μ} ]}^{T} ,$$

and the second RS or RS resource could be referred to as a difference beam having a beam pattern/structure of

$${\frac{1}{\sqrt{{N}_{t}}} [ 1 , … , {e}^{- j ( \frac{{N}_{t}}{2} - 1 ) μ} , - {e}^{- j ( \frac{{N}_{t}}{2} ) μ} , … , - {e}^{- j ( {N}_{t} - 1 ) μ} ]}^{T} ,$$

where Nₜ represents the total number of (transmit) antenna elements, and μ is the steering direction. Furthermore, denote the received signals or signal samples for the sum and difference beams as rx_sig_s and rx_sig_d. The UE could then determine, identify or formulate a first sum-difference function as

$$f ( θ ) = ℶ \{ rx\_sig \_s / rx\_sig \_d \} ,$$

where θ is the actual channel angular direction, and [symbol] {x} extracts the imaginary part of the input x. The corresponding first sum-difference function can be further expressed as

$$f ( θ ) = \frac{sin ( \frac{{N}_{t}}{2} ( θ - μ ) )}{1 - cos ( \frac{{N}_{t}}{2} ( θ - μ ) )} = cot ( \frac{{N}_{t}}{4} ( θ - μ ) ) .$$

The UE could then invert the first sum-difference function ƒ(·) and obtain the corresponding channel angle estimation result as

$$\hat{θ} = {f}^{- 1} ( θ ) = μ + \frac{4}{{N}_{t}} {cos}^{- 1} ( \frac{{N}_{t}}{4} ( θ - μ ) ) .$$

Method-2: the first RS or RS resource could be referred to as a sum beam having a beam pattern/structure of

$${\frac{1}{\sqrt{{N}_{t}}} [ 1 , … , {e}^{- j {μ}_{a}} , {e}^{- j ( \frac{{N}_{t}}{2} - 1 ) {μ}_{a}} , … , {e}^{- j ( {N}_{t} - 1 ) {μ}_{a}} ]}^{T} ,$$

and the second RS or RS resource could be referred to as a difference beam having a beam pattern/structure of

$${\frac{1}{\sqrt{{N}_{t}}} [ 1 , … , {e}^{- j {μ}_{b}} , {e}^{- j ( \frac{{N}_{t}}{2} - 1 ) {μ}_{b}} , {e}^{- j ( \frac{{N}_{t}}{2} ) {μ}_{b}} , … , {e}^{- j ( {N}_{t} - 1 ) {μ}_{b}} ]}^{T} ,$$

where μₐ and μ_{b} are the steering directions of the sum and difference beams respectively. Furthermore, denote the received signal qualities such as L1 measurements including L1-RSRPs for the sum and difference beams as rx_pw_s and rx_pw_d. The UE could then determine, identify or formulate a second sum-difference function as

$$f ( θ ) = ( rx\_pw \_s - rx\_pw \_d ) / ( rx\_pw \_s + rx\_pw \_d ) ,$$

where θ is the actual channel angular direction. If μₐ=μ−δ and μ_{b}=μ+δ, the second sum-difference function can be rewritten as

$$f ( θ ) = - \frac{sin ( θ - μ ) sin ( δ )}{1 - cos ( θ - μ ) cos ( δ )} .$$

The UE can then invert the second sum-difference function ƒ(·) and obtain the corresponding channel angle estimation result as

$$\hat{θ} = {f}^{- 1} ( θ ) = μ - {sin}^{- 1} ( \frac{f ( θ ) sin ( δ ) - f ( θ ) \sqrt{1 - {f}^{2} ( θ )} sin ( δ ) cos ( δ )}{{sin}^{2} ( δ ) + {f}^{2} ( θ ) {cos}^{2} ( δ )} ) .$$

For Method-1 and/or Method-2 as specified/defined herein in the present disclosure,
In one example (example-A), the UE could be configured or provided by the network, e.g., via/in/by higher layer RRC signaling(s)/parameter(s) CSI-ReportConfig and/or CSI-ResourceConfig, a first RS or RS resource set provided by csi-RS-ResourceSet-SumBeam comprising one or more RSs or RS resources (e.g., in terms/form of their corresponding RS/resource IDs/indexes), and a second RS or RS resource set provided by csi-RS-ResourceSet-DiffBeam comprising one or more RSs or RS resources (e.g., in terms/form of their corresponding RS/resource IDs/indexes). The first and second sets of RSs or RS resources could have the same number of RSs or RS resources configured or provided therein, and each RS or RS resource (e.g., in terms/form of its corresponding RS/resource ID/index) in the first set could be associated, mapped or linked to a RS or RS resource (e.g., in terms/form of its corresponding RS/resource ID/index) in the second set; in this case, the UE could determine or identify the association(s), mapping(s) and/or linkage(s) according to or based on one or more of:
   fixed rule(s) in system specification(s) and/or per RRC (re-)configuration: for instance, the k-th entry (hence the corresponding RS/RS resource or RS/RS resource ID/index) of/in the first set could be associated, mapped or linked to the k-th entry (hence the corresponding RS/RS resource or RS/RS resource ID/index) of/in the second set, wherein k=1, . . . , K, and K represents the total number of RS(s) or RS resource(s)—e.g., in terms/form the corresponding RS/resource ID(s)/index(es)—configured/provided in the first (or second) set. Alternatively, the RS/RS resource with the k-th lowest (or highest) RS/resource ID/index—among all the K≥1 RS(s)/RS resource(s) in the first set wherein k=1, . . . , K—configured/provided in the first set could be associated, mapped or linked to the RS/RS resource with the k-th lowest (or highest) RS/resource ID/index—among all the K≥1 RS(s)/RS resource(s) in the second set wherein k=1, . . . , K—configured/provided in the second set.
   network's configuration(s) or indication(s) e.g. via higher layer RRC signaling(s)/parameter(s) and/or MAC CE command(s) and/or dynamic DCI based L1 signaling(s) based on or according to a corresponding UE's capability or capability signaling: for instance, the UE could be provided or configured by the network, e.g., via higher layer RRC signaling(s)/parameter(s) CSI-ReportConfig and/or CSI-ResourceConfig, a list of RS/RS resource ID(s)/index(es); in this case, for a given RS/RS resource ID/index in the list, the RS or RS resource in the first set associated/configured with the given RS/RS resource ID/index could be associated, mapped or linked to the RS or RS resource in the second set associated/configured with the (same) given RS/RS resource ID/index.
   UE's autonomous determination or selection, which could be further sent or transmitted to the network via various UL channels/signals such as CSI/beam report and/or UE's capability signaling(s)

For this design example, a RS or RS resource (in terms/form of its corresponding or respective RS/resource ID or index)—denoted by a first RS or RS resource—in the first set and its associated, mapped or linked RS or RS resource (in terms/form of its corresponding or respective RS/resource ID or index)—denoted by a second RS or RS resource—in the second set could respectively correspond to a sum beam (or a sum beam RS or RS resource) and a difference beam (or a difference beam RS or RS resource) according to or following those specified/defined herein in the present disclosure, or vice versa. When/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned first set, the UE could then determine or identify that the determined or identified RS(s) or RS resource(s) could correspond to a sum (or difference) beam RS(s) or RS resource(s) as specified/defined herein in the present disclosure:
furthermore, the UE could identify or determine, based on the association(s), mapping(s) or linkage(s) defined/specified herein in the present disclosure, a difference (or sum) beam RS(s) or RS resource(s) from the second set associated, mapped or linked to the sum (or difference) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure,
and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned second set, the UE could then determine or identify that the determined or identified RS(s) or RS resource(s) could correspond to a difference (or sum) beam RS(s) or RS resource(s) as specified/defined herein in the present disclosure:
furthermore, the UE could identify or determine, based on the association(s), mapping(s) or linkage(s) defined/specified herein in the present disclosure, a sum (or difference) beam RS(s) or RS resource(s) from the first set associated, mapped or linked to the difference (or sum) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure.
In another example (example-B), the UE could be configured or provided by the network, e.g., via/in/by higher layer RRC signaling(s)/parameter(s) CSI-ReportConfig and/or CSI-ResourceConfig, a RS or RS resource set provided by csi-RS-ResourceSet-SumDiffBeam comprising one or more RSs or RS resources (e.g., in terms/form of their corresponding RS/resource IDs/indexes). For this design example, the UE could determine or identify sum and/or difference beam RS(s) or RS resource(s)—e.g., in terms/form of the corresponding RS/resource ID(s)/index(es)—from/in the RS or RS resource set according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
For example, the first half of the RS(s) or RS resource(s) in the set could correspond to sum beam RS(s) or RS resource(s), and the rest of the RS(s) or RS resource(s) in the set could correspond to difference beam RS(s) or RS resource(s), or vice versa.
For another example, the RS(s) or RS resource(s) with odd (or even) resource ID(s)/index(es) in the set could correspond to sum beam RS(s) or RS resource(s), and the RS(s) or RS resource(s) with even (or odd) resource ID(s)/index(es) in the set could correspond to difference beam RS(s) or RS resource(s).
For another example, the UE could be provided or configured by the network e.g. via higher layer RRC signaling(s)/parameter(s) CSI-ReportConfig and/or CSI-ResourceConfig a bitmap associated/corresponding/specific to the set with each entry/bit position of the bitmap corresponding to a RS or RS resource—e.g., in terms/form of its RS/resource ID/index—in the set. In this case, when/if an entry/bit position of/in the bitmap is set to ‘1’ (or ‘0’), the RS or RS resource corresponding to the entry/bit position could correspond to a sum beam RS or RS resource, and when/if an entry/bit position of/in the bitmap is set to ‘0’ (or ‘1’), the RS or RS resource corresponding to the entry/bit position could correspond to a difference beam RS or RS resource.
For another example, higher layer parameter(s)/signaling(s) e.g. NZP-CSI-RS-Resource that provides or configures a RS or RS resource in the set could contain, comprise, include, configure or provide an indicator; when/if the indicator is set to ‘1’ (or ‘0’) or ‘sumBeam’, the RS or RS resource could correspond to a sum beam RS or RS resource as specified or defined herein in the present disclosure, and when/if the indicator is set to ‘0’ (or ‘1’) or ‘diffBeam’, the RS or RS resource could correspond to a difference beam RS or RS resource as specified or defined herein in the present disclosure.

The UE could determine or identify association(s), mapping(s) and/or linkage(s) between sum and difference beam RSs or RS resources according to or based on:
For example, the UE could first identify or determine a set A of RS(s) or RS resource(s)—e.g., in terms/form of the corresponding RS/resource ID(s)/index(es)—comprising the sum beam RS(s) or RS resource(s) from/in the set, and a set B of RS(s) or RS resource(s)—e.g., in terms/form of the corresponding RS/resource ID(s)/index(es)—comprising the difference beam RS(s) or RS resource(s) from/in the set. In this case, the UE could determine or identify the association(s), mapping(s) and/or linkage(s) between the sum and difference beam RSs or RS resources according to or based on those specified or described or defined in the example-A by replacing the first set in the example-A with the set A and the second set in the example-A with the set B.
For another example, for the set provided by csi-RS-Resource Set-SumDiffBeam, when/if the n-th entry in/of the set or the RS or RS resource with the n-th lowest (or highest) RS/resource ID/index in/of the set corresponds to a sum beam RS or RS resource, and the (n−1)-th and/or (n+1)-th entry in/of the set or the RS(s) or RS resource(s) with the (n−1)-th and/or (n+1)-th lowest (or highest) RS/resource ID(s)/index(es) in/of the set corresponds to difference beam RS(s) or RS resource(s), the UE could determine or identify that the sum beam RS or RS resource here could be associated, mapped or linked to the difference beam RS(s) or RS resource(s) defined in this example, wherein n∈{1, . . . , N} and N represents the total number of RS(s) or RS resource(s) in the set.
For another example, for the set provided by csi-RS-Resource Set-SumDiffBeam, when/if the n-th entry in/of the set or the RS or RS resource with the n-th lowest (or highest) RS/resource ID/index in/of the set corresponds to a difference beam RS or RS resource, and the (n−1)-th and/or (n+1)-th entry in/of the set or the RS(s) or RS resource(s) with the (n−1)-th and/or (n+1)-th lowest (or highest) RS/resource ID(s)/index(es) in/of the set corresponds to sum beam RS(s) or RS resource(s), the UE could determine or identify that the difference beam RS or RS resource here could be associated, mapped or linked to the sum beam RS(s) or RS resource(s) defined in this example, wherein n∈{1, . . . , N} and N represents the total number of RS(s) or RS resource(s) in the set.

For this design example, when/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) corresponds to a sum (or difference) beam RS(s) or RS resource(s) according to or following those specified/defined herein in the present disclosure:
the UE could identify or determine, based on the association(s), mapping(s) or linkage(s) defined/specified herein in the present disclosure, a difference (or sum) beam RS(s) or RS resource(s) associated, mapped or linked to the sum (or difference) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure,
and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) corresponds to a difference (or sum) beam RS(s) or RS resource(s) as specified/defined herein in the present disclosure:
the UE could identify or determine, based on the association(s), mapping(s) or linkage(s) defined/specified herein in the present disclosure, a sum (or difference) beam RS(s) or RS resource(s) associated, mapped or linked to the difference (or sum) beam RS(s) or RS resource(s);
in addition, the UE could then derive, determine or identify, based on the identified or determined sum and difference beam RSs or RS resources, a/th corresponding sum-difference function ƒ(·), and obtain the corresponding channel angle estimation result according to or following those specified herein in the present disclosure.

According to or following those specified or defined herein in the present disclosure,
when/if the UE is provided or configured by the network a set of RSs or RS resources comprising both sum beam RS(s) or RS resource(s) and difference RS(s) or RS resource(s), the UE could determine or identify which of the RSs or RS resources in the set corresponding to sum beam RS(s) or RS resource(s), and/or which of the RSs or RS resources in the set corresponding to difference beam RS(s) or RS resource(s) according to or based on (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS(s) or RS resource(s) in the set could correspond to sum beam RS(s) or RS resource(s), and the rest of the RS(s) or RS resource(s) in the set could correspond to difference beam RS(s) or RS resource(s), or vice versa.
   For another example, the RS(s) or RS resource(s) with odd (or even) resource ID(s)/index(es) in the set could correspond to sum beam RS(s) or RS resource(s), and the RS(s) or RS resource(s) with even (or odd) resource ID(s)/index(es) in the set could correspond to difference beam RS(s) or RS resource(s).
   For another example, the UE could be provided or configured by the network e.g. via higher layer RRC signaling(s)/parameter(s) CSI-ReportConfig and/or CSI-ResourceConfig a bitmap associated/corresponding/specific to the set with each entry/bit position of the bitmap corresponding to a RS or RS resource—e.g., in terms/form of its RS/resource ID/index—in the set. In this case, when/if an entry/bit position of/in the bitmap is set to ‘1’ (or ‘0’), the RS or RS resource corresponding to the entry/bit position could correspond to a sum beam RS or RS resource, and when/if an entry/bit position of/in the bitmap is set to ‘0’ (or ‘1’), the RS or RS resource corresponding to the entry/bit position could correspond to a difference beam RS or RS resource.
   For another example, higher layer parameter(s)/signaling(s) e.g. NZP-CSI-RS-Resource that provides or configures a RS or RS resource in the set could contain, comprise, include, configure or provide an indicator; when/if the indicator is set to ‘1’ (or ‘0’) or ‘sumBeam’, the RS or RS resource could correspond to a sum beam RS or RS resource as specified or defined herein in the present disclosure, and when/if the indicator is set to ‘0’ (or ‘1’) or ‘diffBeam’, the RS or RS resource could correspond to a difference beam RS or RS resource as specified or defined herein in the present disclosure.
when/if the UE is provided or configured by the network one or more sets of RSs or RS resources—denoted by RS or RS resource set(s) herein—comprising both one or more sets of sum beam RS(s) or RS resource(s) denoted by sum beam RS or RS resource set(s) herein and one or more sets of difference RS(s) or RS resource(s) denoted by difference beam RS or RS resource set(s) herein, the UE could determine or identify which of the RS or RS resource set(s) corresponding to sum beam RS or RS resource set(s), and/or which of the RS or RS resource set(s) corresponding to difference beam RS or RS resource set(s) according to or based on (i) fixed value(s)/rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
   For example, the first half of the RS or RS resource set(s) could correspond to sum beam RS or RS resource set(s), and the rest of the RS or RS resource set(s) could correspond to difference beam RS or RS resource set(s), or vice versa.
   For another example, the RS or RS resource set(s) with odd (or even) resource set ID(s)/index(es) could correspond to sum beam RS or RS resource set(s), and the RS or RS resource set(s) with even (or odd) resource set ID(s)/index(es) could correspond to difference beam RS or RS resource set(s).
   For another example, the UE could be provided or configured by the network e.g. via higher layer RRC signaling(s)/parameter(s) CSI-ReportConfig and/or CSI-ResourceConfig a bitmap with each entry/bit position of the bitmap corresponding to a RS or RS resource set. In this case, when/if an entry/bit position of/in the bitmap is set to ‘1’ (or ‘0’), the RS or RS resource set corresponding to the entry/bit position could correspond to a sum beam RS or RS resource set, and when/if an entry/bit position of/in the bitmap is set to ‘0’ (or ‘1’), the RS or RS resource set corresponding to the entry/bit position could correspond to a difference beam RS or RS resource set.
   For another example, higher layer parameter(s)/signaling(s) e.g. NZP-CSI-RS-ResourceSet that provides or configures a RS or RS resource set could contain, comprise, include, configure or provide an indicator; when/if the indicator is set to ‘1’ (or ‘0’) or ‘sumBeam’, the RS or RS resource set could correspond to a sum beam RS or RS resource set as specified or defined herein in the present disclosure, and when/if the indicator is set to ‘0’ (or ‘1’) or ‘diffBeam’, the RS or RS resource set could correspond to a difference beam RS or RS resource set as specified or defined herein in the present disclosure.

For Method-1 and/or Method-2 as specified/defined herein in the present disclosure, a UE could report, in a CSI/beam report or a reporting instance, one or more of:
The aforementioned channel angle estimation result(s) \hat{θ}, which could be quantized to a x-bit value with y-bit step size, wherein the UE could be determine or identify the value(s) of x and/or y according to or based on: (1) fixed value(s) in system specification(s) and/or per RRC (re-)configuration, (2) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection or decision, which could be further sent or transmitted to the network via various UL channels/signals such as CSI/beam report and/or UE's capability signaling(s)
Index of the aforementioned channel angle estimation result(s) B determined or selected from a set (or codebook) of candidate channel angle value(s)
Resource indicator (SSBRI/CRI) of the first RS/RS resource and/or the beam metric (L1-RSRP/L1-SINR) corresponding to the first RS/RS resource
Resource indicator (SSBRI/CRI) of the second RS/RS resource and/or the beam metric (L1-RSRP/L1-SINR) corresponding to the second RS/RS resource
Channel state information (CSI) report for the first RS/RS resource
Channel state information (CSI) report for the second RS/RS resource

According to or following those specified/defined herein in the present disclosure, a UE could use or apply or follow those specified/described in Method-1 and/or Method-2 to perform measurement(s) and/or reporting(s) according to or based on:
Fixed rule(s) and/or event(s) in system specification(s) and/or per RRC (re-)configuration,
   in one example, the beam metric e.g. the measured L1-RSRP for the second RS or RS resource (i.e., the difference beam) is greater than or equal to a first threshold;
   in another example, the beam metric e.g. the measured L1-RSRP for the first RS or RS resource (i.e., the sum beam) is less (or greater) than or equal to a second threshold, and the beam metric e.g. the measured L1-RSRP for the second RS or RS resource (i.e., the difference beam) is greater than or equal to a third threshold;
   in another example, the difference between the beam metric e.g. the measured L1-RSRP for the first RS or RS resource (i.e., the sum beam) and the beam metric e.g. the measured L1-RSRP for the second RS or RS resource (i.e., the difference beam) is less (or greater) than or equal to a fourth threshold, and/or the sum of the beam metric e.g. the measured L1-RSRP for the first RS or RS resource (i.e., the sum beam) and the beam metric e.g. the measured L1-RSRP for the second RS or RS resource (i.e., the difference beam) is greater (or less) than or equal to a fifth threshold.

The UE could determine or identify the first, second, third, fourth and/or fifth threshold(s) according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling,
   in one example, a pair of the first and second RSs or RS resources as specified/defined herein in the present disclosure are configured or provided
   in another example, the UE is configured or provided by the network, e.g., via higher layer RRC signaling(s)/parameter(s), a higher layer parameter sumdiffBM (e.g. set to ‘enabled’)
   in another example, the UE is configured or provided by the network, e.g., in/via/by higher layer RRC signaling(s)/parameter(s) e.g. in CSI-ReportConfig, the higher layer parameter reportQuantity set to ‘sumdiffBeam’.
UE's autonomous determination or selection or decision based on or according to one or more of:
   in one example, the beam metric e.g. the measured L1-RSRP for the second RS or RS resource (i.e., the difference beam) is greater than or equal to a first threshold;
   in another example, the beam metric e.g. the measured L1-RSRP for the first RS or RS resource (i.e., the sum beam) is less (or greater) than or equal to a second threshold, and the beam metric e.g. the measured L1-RSRP for the second RS or RS resource (i.e., the difference beam) is greater than or equal to a third threshold;
   in another example, the difference between the beam metric e.g. the measured L1-RSRP for the first RS or RS resource (i.e., the sum beam) and the beam metric e.g. the measured L1-RSRP for the second RS or RS resource (i.e., the difference beam) is less (or greater) than or equal to a fourth threshold, and/or the sum of the beam metric e.g. the measured L1-RSRP for the first RS or RS resource (i.e., the sum beam) and the beam metric e.g. the measured L1-RSRP for the second RS or RS resource (i.e., the difference beam) is greater (or less) than or equal to a fifth threshold,
wherein the UE could determine or identify the first, second, third, fourth and/or fifth threshold(s) according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s). In this case, the UE's autonomous determination or selection or decision could be further sent or transmitted to the network via various UL channels/signals such as CSI/beam report and/or UE's capability signaling(s). In this case, the corresponding CSI/beam report or reporting instance could also contain, comprise, include, provide or indicate an indicator (e.g., a one-bit indicator set to ‘1’ (or ‘0’)) to indicate that the report quantity(s)/content(s) in the CSI/beam report or the reporting instance is determined or identified by the UE according to the measurement(s) obtained by using, applying or following those specified/described in Method-1 and/or Method-2.

Furthermore, the UE could determine or identify which of the Method-1 and Method-2 to use or apply or follow to perform measurement(s) and/or reporting(s) according to or based on:
Fixed rule(s) and/or event(s) in system specification(s) and/or per RRC (re-)configuration.
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling,
   in one example, the UE could use or apply or follow those specified/described in at least Method-1 to perform measurement(s) and/or reporting(s) when/if:
      a pair of the first and second RSs or RS resources as specified/defined in Method-1 are configured or provided, and/or
      the UE is configured or provided by the network, e.g., via higher layer RRC signaling(s)/parameter(s), a higher layer parameter sumdiffBMType set to ‘method-1’ or ‘differentialBeams’ or ‘both’;
   in another example, the UE could use or apply or follow those specified/described in at least Method-2 to perform measurement(s) and/or reporting(s) when/if:
      a pair of the first and second RSs or RS resources as specified/defined in Method-2 are configured or provided, and/or
      the UE is configured or provided by the network, e.g., via higher layer RRC signaling(s)/parameter(s), a higher layer parameter sumdiffBMType set to ‘method-2’ or ‘overlappingBeams’ or ‘both’.
UE's autonomous determination or selection or decision, which could be further sent or transmitted to the network via various UL channels/signals such as CSI/beam report and/or UE's capability signaling(s). In this case, the corresponding CSI/beam report or reporting instance could also contain, comprise, include, provide or indicate an indicator (e.g., a one-bit indicator that can be set to ‘0’ or ‘1’ or a two-bit indicator that can be set to ‘00’, ‘01’, ‘10’ or ‘11’). In this case,
   When/if the indicator is set to ‘0’ (or ‘1’) or ‘00’ (or ‘01’ or ‘10’ or ‘11’), the report quantity(s)/content(s) in the CSI/beam report or the reporting instance is determined or identified by the UE according to the measurement(s) obtained by using, applying or following those specified/described in at least Method-1, and/or
   When/if the indicator is set to ‘1’ (or ‘0’) or ‘01’ (or ‘00’ or ‘10’ or ‘11’), the report quantity(s)/content(s) in the CSI/beam report or the reporting instance is determined or identified by the UE according to the measurement(s) obtained by using, applying or following those specified/described in at least Method-2, and/or
   When/if the indicator is set to ‘0’ or ‘1’ or ‘10’ or ‘11’ (or ‘00’ or ‘01’), the report quantity(s)/content(s) in the CSI/beam report or the reporting instance is determined or identified by the UE according to the measurement(s) obtained by using, applying or following those specified/described in both Method-1 and Method-2.

For Method-1 and/or Method-2 as specified/defined herein in the present disclosure, after a UE has sent or transmitted to the network the CSI/beam report according to or following those specified herein in the present disclosure, the UE could expect to receive form the network a corresponding response e.g. (i) X symbol(s)/slot(s)/etc. after a last symbol/slot/etc. of transmission of the CSI/beam report, and/or (ii) within Y symbol(s)/slot(s)/etc. after a last symbol/slot/etc. of transmission of the CSI/beam report, wherein the UE could determine or identify value(s) of X and/or Y according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s). Furthermore, the network's response could be in form of one or more of:
A one-bit ACK/NACK indicator
A TCI state update indicated e.g. via a codepoint of a (unified) TCI state(s) activation/deactivation MAC CE and/or a TCI codepoint of a/the TCI field in a beam indication DCI (e.g., DCI format(s) 1_1/1_2 with or without DL assignment)

When/if the network's response is indicated via a DCI, the network's response could be provided to the UE via a new/dedicated DCI field, or by repurposing one or more codepoints of one or more existing DCI fields in the corresponding DCI format(s).

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 10, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 00, DCI format 01, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

A UE could receive from the network a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL BWPs, and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein all of the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals
   That is, all of the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),
   and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),
   and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applyIndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is configured/present and/or set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

That is, for PDSCH reception in a (single-DCI based) multi-TRP system, when a UE is configured with dl-OrJointTCU-StateList and is having two indicated TCI-states, if the UE does not report its capability indicating support of “two default beams for S-DCI based MTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE is configured with dl-OrJointTCJ-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI based MTRP” in frequency range 2, or
If the UE does not report its capability indicating support of “two default beams for S-DCI based MTRP” in frequency range 2 and if the scheduling offset between the reception of the scheduling DCI format 1_0/1_1/1_2 and the scheduled/activated PDSCH reception is equal to or larger than timeDurationForQCL
The UE can be configured by higher layer parameter applyIndicatedTCIState to indicate whether the first, the second, or both of the indicated TCI-state(s) is/are applied to PDSCH reception scheduled or activated by DCI format 1_0. The UE can be configured with applyIndicatedTCIState with value both only when the UE is configured with cjtSchemePDSCH and the UE reports its capability indicating support of two joint TCI states for PDSCH-CJT or the UE is configured with sfnSchemePdsch. In that case, the UE shall apply both indicated TCI-states to PDSCH reception scheduled or activated by DCI format 1_0 on a search space other than Type0/0A/2 CSS on CORESET #0.
If the UE is not configured with applyIndicatedTCIState, the first indicated TCI-state is applied to PDSCH reception scheduled or activated by DCI format 1_0.
When the UE is configured with tciSelection-PresentlnDCI jointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
If the DCI format 1_1/1_2 indicates codepoint “00” for the TCI selection field (or equivalently, the second indicator as specified herein in the present disclosure), the UE shall apply the first one of two indicated joint/DL TCI states to all PDSCH DM-RS port(s) of corresponding PDSCH transmission occasions(s) scheduled or activated by the DCI format 1_1/1_2.
If the DCI format 1_1/1_2 indicates codepoint “01” for the TCI selection field (or equivalently, the second indicator as specified herein in the present disclosure), the UE shall apply the second one of two indicated joint/DL TCI states to all PDSCH DM-RS port(s) of corresponding PDSCH transmission occasion(s) scheduled or activated by the DCI format 1_1/1_2.
If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
If the UE is not configured with tciSelection-PresentinDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting a third indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

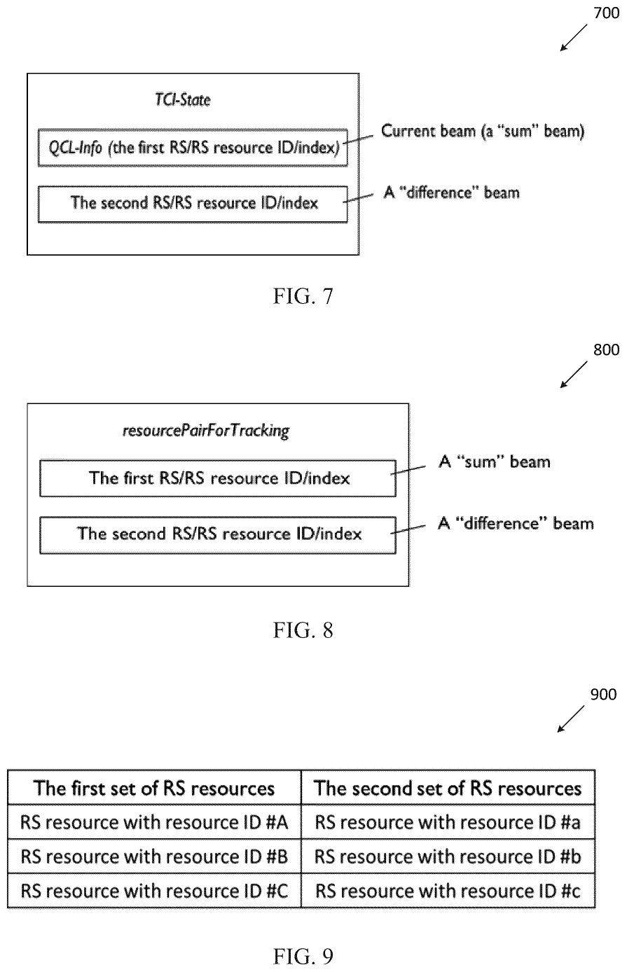

FIG. 7 illustrates an example of using a TCI state to indicate a pair of RSs for beam tracking 700 according to embodiments of the present disclosure. The example of using a TCI state to indicate a pair of RSs for beam tracking 700 shown in FIG. 7 is for illustration only and other embodiments can be used without departing from the scope of the present disclosure.

In one embodiment, a UE could use or apply a first TCI state—e.g., a first RS or RS resource associated with, e.g., indicated in/by, the first TCI state—to determine or identify spatial domain filter(s) for transmitting various uplink channel(s) and/or signal(s) including PUCCH(s), PUSCH(s) and/or SRS(s), and/or for receiving various downlink channel(s) and/or signal(s) including PDCCH(s), PDSCH(s) and/or CSI-RS(s) according to or following those specified herein in the present disclosure. In particular, the first RS or RS resource could correspond to:
Scheme-1: a/the CSI-RS resource/resource configuration—e.g. served as a/the QCL source RS/RS resource—indicated in/by the first TCI state, wherein the CSI-RS resource/resource configuration could be provided in a CSI resource set configured with ‘repetition’ set to ‘on’, and/or a CSI resource set configured with ‘trs-Info’
Scheme-2: a/the SSB quasi-co-located (QCL'ed)—e.g. of QCL-TypeD—with a/the QCL source RS/RS resource (e.g., corresponding to a/the aforementioned CSI-RS resource/resource configuration) indicated in/by the first TCI state

The UE could determine or identify the first RS or RS resource following Scheme-1 or Scheme-2 based on or according to network's configuration(s)/indication(s)—e.g., Scheme-1 or Scheme-2 is enabled for determining or identifying the first RS or RS resource—via higher layer RRC signaling(s)/parameter(s) and/or MAC CE command(s) and/or dynamic DCI based L1 signaling(s) according to or based on a corresponding UE's capability or capability signaling. For beam(s) tracking,
In one example, the first TCI state (and therefore, the first RS or RS resource) could be associated to a second RS or RS resource, wherein the second RS or RS resource could be different or separate from the first RS or RS resource; for this design example, the UE could determine or identify the association between the first TCI state (and therefore, the first RS or RS resource) and the second RS or RS resource according to or following one or more of:
   For example, higher layer parameter(s)/signaling(s) e.g. TCI-State that provides or configures the first TCI state could also provide or configure or comprise or include or contain or indicate the second RS or RS resource—e.g., in form/terms of the corresponding RS or RS resource ID/index (one conceptual example is presented in FIG. 7); alternatively, higher layer parameter(s)/signaling(s) e.g. NZP-CSI-RS-Resource that provides or configures the second RS or RS resource could also provide or configure or comprise or include or contain or indicate the first TCI state—e.g., in form/terms of the corresponding TCI state ID/index; optionally, higher layer parameter(s)/signaling(s) e.g. TCI-State that provides or configures the first TCI state could also provide or configure or comprise or include or contain or indicate a first entity ID, and higher layer parameter(s)/signaling(s) e.g. NZP-CSI-RS-Resource that provides or configures the second RS or RS resource could also provide or configure or comprise or include or contain or indicate a second entity ID, wherein the first and second entity IDs could be identical or same, or could have a/same value.

FIG. 8 illustrates an example of configuring or indicating a pair of RSs for beam tracking 800 according to embodiments of the present disclosure. The example of configuring or indicating a pair of RSs for beam tracking 800 as shown in FIG. 8 is for illustration only and other embodiments can be used without departing from the scope of the present disclosure.

FIG. 9 illustrates an example of using a lookup table to determine the association/mapping relation between RSs/RS resources for beam tracking 900 according to embodiments of the present disclosure. The example of using a lookup table to determine the association/mapping relation between RSs/RS resources for beam tracking 900 as shown in FIG. 9 is for illustration only and other embodiments can be used without departing from the scope of the present disclosure.
For another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, an association/mapping relation between the first and second RSs/RS resources:
   In one example, the first and second RSs/RS resources—e.g., in terms/form of their RS/resource IDs/indexes—could be provided or configured in/as a/the same resource set, resource group, resource pair and/or etc. In FIG. 8, a conceptual example of a resource pair for tracking provided by a higher layer parameter resourcePairForTracking is presented.
   In another example, the first and second RSs/RS resources—e.g., in terms/form of their RS/resource IDs/indexes—could be provided or configured or activated or indicated in/by a/the same higher layer RRC signaling(s)/parameter(s) and/or MAC CE command(s) and/or dynamic DCI based L1 signaling(s).
   In another example, the higher layer parameter(s)/signaling(s) that provides or configures the first RS/RS resource e.g. NZP-CSI-RS-Resource could also provide or configure a first entity ID, and the higher layer parameter(s)/signaling(s) that provides or configures the second RS/RS resource e.g. NZP-CSI-RS-Resource could also provide or configure a second entity ID, wherein the first and second entity IDs could be identical or same, or could have a/same value.
   In another example, the first RS/RS resource e.g. in terms/form of the corresponding RS/RS resource ID/index could be provided or configured in a first list/set/group/pair of RS(s) or RS resource(s) as/corresponding to the k-th entry of/in the first list/set/group/pair, and the second RS/RS resource e.g. in terms/form of the corresponding RS/RS resource ID/index could be provided or configured in a second list/set/group/pair of RS(s) or RS resource(s) as/corresponding to the 1-th entry of/in the second list/set/group/pair, wherein k=1.
   In another example, the higher layer parameter(s)/signaling(s) that provides or configures the first RS/RS resource e.g. NZP-CSI-RS-Resource could also provide or configure the second RS/RS resource e.g. in form/terms of the corresponding RS/resource ID/index.
   In another example, the higher layer parameter(s)/signaling(s) that provides or configures the second RS/RS resource e.g. NZP-CSI-RS-Resource could also provide or configure the first RS/RS resource e.g. in form/terms of the corresponding RS/resource ID/index.
   In another example, the UE could be provided or configured or indicated by the network, e.g., via higher layer RRC signaling(s)/parameter(s) and/or MAC CE command(s) and/or dynamic DCI based L1 signaling(s), a look-up table, wherein the first and second RS or RS resources—e.g., in terms/form of their RS or RS resource IDs/indexes—could correspond to two neighboring entries, or entries of two neighboring rows, or entries of two neighboring columns in the look-up table.
   In another example, the first and second RSs or RS resources—e.g., in terms/form of their RS/resource IDs/indexes—could be provided or configured in/as a/the same resource set; for this design example, the first and second RSs or RS resources could be respectively associated to/with a first and a second entity IDs (e.g., provided or configured in higher layer parameter(s)/signaling(s) that provides or configures the resource set), wherein the first and second entity IDs could be identical or same, or could have a/same value.
   In another example, the UE could be configured or provided by the network, e.g., via/in/by higher layer RRC signaling(s)/parameter(s) CSI-ReportConfig and/or CSI-ResourceConfig, a first RS or RS resource set provided by csi-RS-ResourceSet-SumBeam comprising one or more RSs or RS resources (e.g., in terms/form of their corresponding RS/resource IDs/indexes), and a second RS or RS resource set provided by csi-RS-ResourceSet-DiffBeam comprising one or more RSs or RS resources (e.g., in terms/form of their corresponding RS/resource IDs/indexes). The first and second sets of RSs or RS resources could have the same number of RSs or RS resources configured or provided therein, and each RS or RS resource (e.g., in terms/form of its corresponding RS/resource ID/index) in the first set could be associated, mapped or linked to a RS or RS resource (e.g., in terms/form of its corresponding RS/resource ID/index) in the second set; in this case, the UE could determine or identify the association(s), mapping(s) and/or linkage(s) according to or based on one or more of:
      fixed rule(s) in system specification(s) and/or per RRC (re-)configuration: for instance, the k-th entry (hence the corresponding RS/RS resource or RS/RS resource ID/index) of/in the first set could be associated, mapped or linked to the k-th entry (hence the corresponding RS/RS resource or RS/RS resource ID/index) of/in the second set, wherein k=1, . . . , K, and K represents the total number of RS(s) or RS resource(s)—e.g., in terms/form the corresponding RS/resource ID(s)/index(es)—configured/provided in the first (or second) set. Alternatively, the RS/RS resource with the k-th lowest (or highest) RS/resource ID/index—among all the K≥1 RS(s)/RS resource(s) in the first set wherein k=1, . . . , K—configured/provided in the first set could be associated, mapped or linked to the RS/RS resource with the k-th lowest (or highest) RS/resource ID/index—among all the K≥1 RS(s)/RS resource(s) in the second set wherein k=1, . . . , K—configured/provided in the second set. In FIG. 9, a look-up table that characterizes the association, mapping or linkage between the RSs or RS resources in the first and second sets is presented, which can be provided or configured to the UE by the network, e.g., via higher layer RRC signaling(s)/parameter(s) and/or MAC CE command(s) and/or dynamic DCI based L1 signaling(s) based on or according to a corresponding UE's capability or capability signaling. As illustrated in the look-up table, the first set comprises RS resources with resource IDs #A, #B and #C, and the second set comprises RS resources with resource IDs #a, #b and #c; in this case, the RS resources with resource IDs #A, #B and #C in the first set are respectively associated, mapped or linked to the RS resources with resource IDs #a, #b and #c in the second set.
   network's configuration(s) or indication(s) e.g. via higher layer RRC signaling(s)/parameter(s) and/or MAC CE command(s) and/or dynamic DCI based L1 signaling(s) based on or according to a corresponding UE's capability or capability signaling: for instance, the UE could be provided or configured by the network, e.g., via higher layer RRC signaling(s)/parameter(s) CSI-ReportConfig and/or CSI-ResourceConfig, a list of RS/RS resource ID(s)/index(es); in this case, for a given RS/RS resource ID/index in the list, the RS or RS resource in the first set associated/configured with the given RS/RS resource ID/index could be associated, mapped or linked to the RS or RS resource in the second set associated/configured with the (same) given RS/RS resource ID/index.
   UE's autonomous determination or selection, which could be further sent or transmitted to the network via various UL channels/signals such as CSI/beam report and/or UE's capability signaling(s)

For this design example, a RS or RS resource (in terms/form of its corresponding or respective RS/resource ID or index)—e.g., corresponding to the aforementioned first RS or RS resource—in the first set and its associated, mapped or linked RS or RS resource (in terms/form of its corresponding or respective RS/resource ID or index)—e.g., corresponding to the aforementioned second RS or RS resource—in the second set could respectively correspond to a sum beam (or a sum beam RS or RS resource) and a difference beam (or a difference beam RS or RS resource) according to or following those specified/defined herein in the present disclosure, or vice versa. When/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned first set, the UE could then determine or identify that the determined or identified RS(s) or RS resource(s) could correspond to a sum (or difference) beam RS(s) or RS resource(s) as specified/defined herein in the present disclosure, and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned second set, the UE could then determine or identify that the determined or identified RS(s) or RS resource(s) could correspond to a difference (or sum) beam RS(s) or RS resource(s) as specified/defined herein in the present disclosure.

In this case, when/if the first RS or RS resource is associated with, e.g. indicated in/by, the first TCI state, the UE could identify or determine, based on or according to the association/mapping relation, the second RS or RS resource.

Furthermore, the second RS or RS resource could be (1) a CSI-RS resource/resource configuration provided in a CSI resource set configured with ‘repetition’ set to ‘on’, and/or a CSI resource set configured with ‘trs-Info’, e.g., when/if the first RS or RS resource is a CSI-RS resource/resource configuration as specified/defined in Scheme-1, or (2) a SSB, e.g., when/if the first RS or RS resource is a SSB as specified/defined in Scheme-2.
In another example, the first TCI state (and therefore, the first RS or RS resource) could be associated to a second TCI state, wherein a second RS or RS resource could be associated with, e.g., indicated in/by, the second TCI state, and/or the first TCI state could be different/separate from the second TCI state (e.g., in form/terms of their respective TCI state IDs/indexes), and/or the second RS or RS resource could be different or separate from the first RS or RS resource (e.g., in form/terms of their respective RS/resource IDs/indexes); for this design example, the UE could determine or identify the association between the first TCI state (and therefore, the first RS or RS resource) and the second TCI state (and therefore, the second RS or RS resource) according to or following one or more of:
   For example, higher layer parameter(s)/signaling(s) e.g. TCI-State that provides or configures the first TCI state could also provide or configure or comprise or include or contain or indicate the second TCI state—e.g., in form/terms of the corresponding TCI state ID/index; alternatively, higher layer parameter(s)/signaling(s) e.g. TCI-State that provides or configures the second TCI state could also provide or configure or comprise or include or contain or indicate the first TCI state—e.g., in form/terms of the corresponding TCI state ID/index; optionally, higher layer parameter(s)/signaling(s) e.g. TCI-State that provides or configures the first TCI state could also provide or configure or comprise or include or contain or indicate a first entity ID, and higher layer parameter(s)/signaling(s) e.g. TCI-State that provides or configures the second TCI state could also provide or configure or comprise or include or contain or indicate a second entity ID, wherein the first and second entity IDs could be identical or same, or could have a/same value.

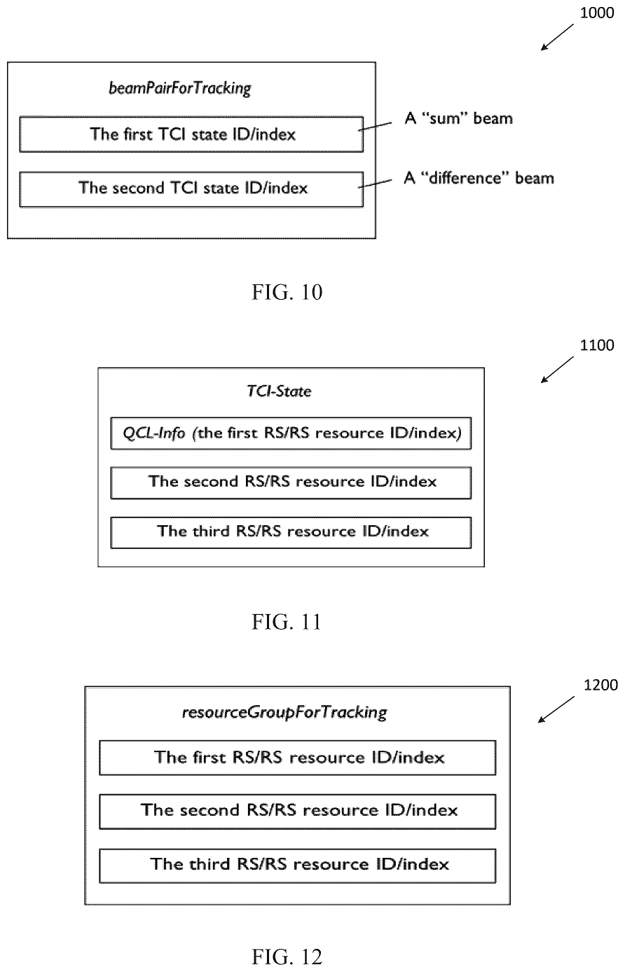

FIG. 10 illustrates an example of configuring or indicating a pair of TCI states for beam tracking 1000 according to embodiments of the present disclosure. The example of configuring or indicating a pair of TCI states for beam tracking 1000 as shown in FIG. 10 is for illustration only and other embodiments can be used without departing from the scope of the present disclosure.
For another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, an association/mapping relation between the first and second TCI states (and therefore, between the first and second RSs/RS resources):
   In one example, the first and second TCI states—e.g., in terms/form of their TCI state IDs/indexes—could be provided or configured in/as a/the same list/set/pool, group and/or pair of TCI states (or TCI state IDs/indexes). In FIG. 10, a conceptual example of a beam pair for tracking provided by a higher layer parameter beamPairForTracking is presented.
   In another example, the first and second TCI states—e.g., in terms/form of their TCI state IDs/indexes—could be provided or configured or activated or indicated in/by a/the same higher layer RRC signaling(s)/parameter(s) and/or MAC CE command(s) and/or dynamic DCI based L1 signaling(s).
   In another example, the higher layer parameter(s)/signaling(s) that provides or configures the first TCI state e.g. TCI-State could also provide or configure a first entity ID, and the higher layer parameter(s)/signaling(s) that provides or configures the second TCI state e.g. TCI-State could also provide or configure a second entity ID, wherein the first and second entity IDs could be identical or same, or could have a/same value.
   In another example, the first TCI state e.g. in terms/form of the corresponding TCI state ID/index could be provided or configured in a first list/set/pool/group/pair of TCI state(s) or TCI state ID(s)/index(es) as/corresponding to the k-th entry in/of the first list/set/pool/group/pair, and the second TCI state e.g. in terms/form of the corresponding TCI state ID/index could be provided or configured in a second list/set/pool/group/pair of TCI state(s) or TCI state ID(s)/index(es) as/corresponding to the 1-th entry in/of the second list/set/pool/group/pair, wherein k=1.
   In another example, the UE could be provided or configured or indicated by the network, e.g., via higher layer RRC signaling(s)/parameter(s) and/or MAC CE command(s) and/or dynamic DCI based L1 signaling(s), a look-up table, wherein the first and second TCI states—e.g., in terms/form of their TCI state IDs/indexes—could correspond to two neighboring entries, or entries of two neighboring rows, or entries of two neighboring columns in the look-up table.
   In another example, the first and second TCI states—e.g., in terms/form of their TCI state IDs/indexes—could be provided or configured in/as a/the same list/set/pool of TCI states (or TCI state IDs/indexes); for this design example, the first and second TCI states could be respectively associated to/with a first and a second entity IDs (e.g., provided or configured in higher layer parameter(s)/signaling(s) that provides or configures the list/set/pool of TCI states/TCI state IDs/indexes), wherein the first and second entity IDs could be identical or same, or could have a/same value.

In this case, when/if the UE has received or indicated or updated by the network the first TCI state (hence the corresponding/associated first RS or RS resource), the UE could identify or determine, based on or according to the association/mapping relation, the second TCI state (hence the corresponding/associated second RS or RS resource).

In particular, the second RS or RS resource could correspond to:
Scheme-i: a/the CSI-RS resource/resource configuration—e.g. served as a/the QCL source RS/RS resource—indicated in/by the second TCI state, wherein the CSI-RS resource/resource configuration could be provided in a CSI resource set configured with ‘repetition’ set to ‘on’, and/or a CSI resource set configured with ‘trs-Info’
Scheme-ii: a/the SSB quasi-co-located (QCL'ed)—e.g. of QCL-TypeD—with a/the QCL source RS/RS resource (e.g., corresponding to a/the aforementioned CSI-RS resource/resource configuration) indicated in/by the second TCI state

The UE could determine or identify the second RS or RS resource following Scheme-i or Scheme-ii based on or according to network's configuration(s)/indication(s)—e.g., Scheme-i or Scheme-ii is enabled for determining or identifying the second RS or RS resource—via higher layer RRC signaling(s)/parameter(s) and/or MAC CE command(s) and/or dynamic DCI based L1 signaling(s) according to or based on a corresponding UE's capability or capability signaling. Alternatively, or optionally, the second RS or RS resource could be (1) a CSI-RS resource/resource configuration provided in a CSI resource set configured with ‘repetition’ set to ‘on’, and/or a CSI resource set configured with ‘trs-Info’, e.g., when/if the first RS or RS resource is a CSI-RS resource/resource configuration as specified/defined in Scheme-1, or (2) a SSB, e.g., when/if the first RS or RS resource is a SSB as specified/defined in Scheme-2.

According to or following those specified herein in the present disclosure, the UE could determine or identify the aforementioned first RS or RS resource as a sum beam (or a sum beam RS or RS resource), and the aforementioned second RS or RS resource as a difference beam (or a difference beam RS or RS resource). The UE could then conduct the measurement and/or reporting procedure(s) with respect to or regarding the sum beam (hence the first RS or RS resource) and the difference beam (hence the second RS or RS resource) according to or following those specified herein in the present disclosure, and the UE may expect to receive from the network a corresponding response—e.g., a TCI state switching/update for beam tracking based on the reported measurement result(s)—according to or following those specified herein in the present disclosure.

FIG. 11 illustrates an example of using a TCI state to indicate a group of three RSs for beam tracking 1100 according to embodiments of the present disclosure. The example of using a TCI state to indicate a group of three RSs for beam tracking 1100 as shown in FIG. 11 is for illustration only and other embodiments can be used without departing from the scope of the present disclosure.

In one embodiment, a UE could use or apply a first TCI state—e.g., a first RS or RS resource associated with, e.g., indicated in/by, the first TCI state—to determine or identify spatial domain filter(s) for transmitting various uplink channel(s) and/or signal(s) including PUCCH(s), PUSCH(s) and/or SRS(s), and/or for receiving various downlink channel(s) and/or signal(s) including PDCCH(s), PDSCH(s) and/or CSI-RS(s) according to or following those specified herein in the present disclosure. In particular, the first RS or RS resource could correspond to:
Scheme-1: a/the CSI-RS resource/resource configuration—e.g. served as a/the QCL source RS/RS resource—indicated in/by the first TCI state, wherein the CSI-RS resource/resource configuration could be provided in a CSI resource set configured with ‘repetition’ set to ‘on’, and/or a CSI resource set configured with ‘trs-Info’
Scheme-2: a/the SSB quasi-co-located (QCL'ed)—e.g. of QCL-TypeD—with a/the QCL source RS/RS resource (e.g., corresponding to a/the aforementioned CSI-RS resource/resource configuration) indicated in/by the first TCI state

The UE could determine or identify the first RS or RS resource following Scheme-1 or Scheme-2 based on or according to network's configuration(s)/indication(s)—e.g., Scheme-1 or Scheme-2 is enabled for determining or identifying the first RS or RS resource—via higher layer RRC signaling(s)/parameter(s) and/or MAC CE command(s) and/or dynamic DCI based L1 signaling(s) according to or based on a corresponding UE's capability or capability signaling. For beam(s) tracking,
In one example, the first TCI state (and therefore, the first RS or RS resource) could be associated to a second RS or RS resource and a third RS or RS resource, wherein the third RS or RS resource could be different or separate from the first RS or RS resource and/or the second RS or RS resource; for this design example, the UE could determine or identify the association between the first TCI state (and therefore, the first RS or RS resource), the second RS or RS resource and/or the third RS or RS resource according to or following one or more of:
   For example, higher layer parameter(s)/signaling(s) e.g. TCI-State that provides or configures the first TCI state could also provide or configure or comprise or include or contain or indicate the second RS or RS resource—e.g., in form/terms of the corresponding RS or RS resource ID/index—and/or the third RS or RS resource—e.g., in form/terms of the corresponding RS or RS resource ID/index (one conceptual example is presented in FIG. 11); alternatively, higher layer parameter(s)/signaling(s) e.g. NZP-CSI-RS-Resource that provides or configures the second RS or RS resource could also provide or configure or comprise or include or contain or indicate the first TCI state—e.g., in form/terms of the corresponding TCI state ID/index—and/or the third RS or RS resource—e.g., in form/terms of the corresponding RS or RS resource ID/index, and/or higher layer parameter(s)/signaling(s) e.g. NZP-CSI-RS-Resource that provides or configures the third RS or RS resource could also provide or configure or comprise or include or contain or indicate the first TCI state—e.g., in form/terms of the corresponding TCI state ID/index—and/or the second RS or RS resource—e.g., in form/terms of the corresponding RS or RS resource ID/index; optionally, higher layer parameter(s)/signaling(s) e.g. TCI-State that provides or configures the first TCI state could also provide or configure or comprise or include or contain or indicate a first entity ID, higher layer parameter(s)/signaling(s) e.g. NZP-CSI-RS-Resource that provides or configures the second RS or RS resource could also provide or configure or comprise or include or contain or indicate a second entity ID, and/or higher layer parameter(s)/signaling(s) e.g. NZP-CSI-RS-Resource that provides or configures the third RS or RS resource could also provide or configure or comprise or include or contain or indicate a third entity ID, wherein the first, second and/or third entity IDs could be identical or same, or could have a/same value.

FIG. 12 illustrates an example of configuring or indicating a group of three RSs for beam tracking 1200 according to embodiments of the present disclosure. The example of configuring or indicating a group of three RSs for beam tracking 1200 as shown in FIG. 12 is for illustration only and other embodiments can be used without departing from the scope of the present disclosure.
For another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, a first association/mapping relation between the first and second RSs/RS resources, a second association/mapping relation between the first and third RSs/RS resources, a third association/mapping relation between the second and third RSs/RS resources, and/or a fourth association/mapping relation between the first, second and third RSs/RS resources:
   In one example, for the fourth association/mapping relation, the first, second and third RSs/RS resources—e.g., in terms/form of their RS/resource IDs/indexes—could be provided or configured in/as a/the same resource set, resource group, resource pair and/or etc. In FIG. 12, a conceptual example of a resource group for tracking provided by a higher layer parameter resourceGroupForTracking is presented, wherein the resource group for tracking characterizes the aforementioned fourth association/mapping relation.
   In another example, for the fourth association/mapping relation, the first, second and third RSs/RS resources—e.g., in terms/form of their RS/resource IDs/indexes—could be provided or configured or activated or indicated in/by a/the same higher layer RRC signaling(s)/parameter(s) and/or MAC CE command(s) and/or dynamic DCI based L1 signaling(s).
   In another example, for the fourth association/mapping relation, the higher layer parameter(s)/signaling(s) that provides or configures the first RS/RS resource e.g. NZP-CSI-RS-Resource could also provide or configure a first entity ID, the higher layer parameter(s)/signaling(s) that provides or configures the second RS/RS resource e.g. NZP-CSI-RS-Resource could also provide or configure a second entity ID, and the higher layer parameter(s)/signaling(s) that provides or configures the third RS/RS resource e.g. NZP-CSI-RS-Resource could also provide or configure a third entity ID, wherein the first, second and third entity IDs could be identical or same, or could have a/same value.
   In another example, for the fourth association/mapping relation, the first RS/RS resource e.g. in terms/form of the corresponding RS/RS resource ID/index could be provided or configured in a first list/set/group/pair of RS(s) or RS resource(s) as/corresponding to the k-th entry of/in the first list/set/group/pair, the second RS/RS resource e.g. in terms/form of the corresponding RS/RS resource ID/index could be provided or configured in a second list/set/group/pair of RS(s) or RS resource(s) as/corresponding to the 1-th entry of/in the second list/set/group/pair, and the third RS/RS resource e.g. in terms/form of the corresponding RS/RS resource ID/index could be provided or configured in a third list/set/group/pair of RS(s) or RS resource(s) as/corresponding to the m-th entry of/in the third list/set/group/pair wherein k=1=m.
   In another example, for the fourth association/mapping relation, the higher layer parameter(s)/signaling(s) that provides or configures the first RS/RS resource e.g. NZP-CSI-RS-Resource could also provide or configure the second and third RSs/RS resources e.g. in form/terms of their corresponding RS/resource IDs/indexes.
   In another example, for the fourth association/mapping relation, the higher layer parameter(s)/signaling(s) that provides or configures the second RS/RS resource e.g. NZP-CSI-RS-Resource could also provide or configure the first and third RSs/RS resources e.g. in form/terms of their corresponding RS/resource IDs/indexes.
   In another example, for the fourth association/mapping relation, the higher layer parameter(s)/signaling(s) that provides or configures the third RS/RS resource e.g. NZP-CSI-RS-Resource could also provide or configure the first and second RSs/RS resources e.g. in form/terms of their corresponding RS/resource IDs/indexes.
   In another example, for the fourth association/mapping relation, the UE could be provided or configured or indicated by the network, e.g., via higher layer RRC signaling(s)/parameter(s) and/or MAC CE command(s) and/or dynamic DCI based L1 signaling(s), a look-up table, wherein the first, second and third RS or RS resources—e.g., in terms/form of their RS or RS resource IDs/indexes—could correspond to three neighboring entries, or entries of three neighboring rows, or entries of three neighboring columns in the look-up table.
   In another example, for the fourth association/mapping relation, the first, second and third RSs or RS resources—e.g., in terms/form of their RS/resource IDs/indexes—could be provided or configured in/as a/the same resource set/group; for this design example, the first, second and third RSs or RS resources could be respectively associated to/with a first, a second and a third entity IDs (e.g., provided or configured in higher layer parameter(s)/signaling(s) that provides or configures the resource set/group), wherein the first, second and third entity IDs could be identical or same, or could have a/same value.
   In another example, for the fourth association/mapping relation, the UE could be configured or provided by the network, e.g., via/in/by higher layer RRC signaling(s)/parameter(s) CSI-ReportConfig and/or CSI-ResourceConfig, a first RS or RS resource set provided by csi-RS-FirstResourceSet comprising one or more RSs or RS resources (e.g., in terms/form of their corresponding RS/resource IDs/indexes), a second RS or RS resource set provided by csi-RS-SecondResourceSet comprising one or more RSs or RS resources (e.g., in terms/form of their corresponding RS/resource IDs/indexes), and a third RS or RS resource set provided by csi-RS-ThirdResourceSet comprising one or more RSs or RS resources (e.g., in terms/form of their corresponding RS/resource IDs/indexes). The first, second and third sets of RSs or RS resources could have the same number of RSs or RS resources configured or provided therein, and each RS or RS resource (e.g., in terms/form of its corresponding RS/resource ID/index) in the first (or second or third) set could be associated, mapped or linked to a RS or RS resource (e.g., in terms/form of its corresponding RS/resource ID/index) in the second (or first or third) set and a RS or RS resource (e.g., in terms/form of its corresponding RS/resource ID/index) in the third (or first or second) set; in this case, the UE could determine or identify the association(s), mapping(s) and/or linkage(s) according to or based on one or more of:
      fixed rule(s) in system specification(s) and/or per RRC (re-)configuration: for instance, the k-th entry (hence the corresponding RS/RS resource or RS/RS resource ID/index) of/in the first (or second or third) set could be associated, mapped or linked to the k-th entry (hence the corresponding RS/RS resource or RS/RS resource ID/index) of/in the second (or first or third) set and the k-th entry (hence the corresponding RS/RS resource or RS/RS resource ID/index) of/in the third (or first or second) set, wherein k=1, . . . , K, and K represents the total number of RS(s) or RS resource(s)—e.g., in terms/form the corresponding RS/resource ID(s)/index(es)—configured/provided in the first (or second or third) set. Alternatively, the RS/RS resource with the k-th lowest (or highest) RS/resource ID/index—among all the K≥1 RS(s)/RS resource(s) in the first (or second or third) set wherein k=1, . . . , K—configured/provided in the first (or second or third) set could be associated, mapped or linked to the RS/RS resource with the k-th lowest (or highest) RS/resource ID/index—among all the K≥1 RS(s)/RS resource(s) in the second (or first or third) set wherein k=1, . . . , K—configured/provided in the second (or first or third) set and the RS/RS resource with the k-th lowest (or highest) RS/resource ID/index—among all the K≥1 RS(s)/RS resource(s) in the third (or first or second) set wherein k=1, . . . , K—configured/provided in the third (or first or second) set.
      network's configuration(s) or indication(s) e.g. via higher layer RRC signaling(s)/parameter(s) and/or MAC CE command(s) and/or dynamic DCI based L1 signaling(s) based on or according to a corresponding UE's capability or capability signaling: for instance, the UE could be provided or configured by the network, e.g., via higher layer RRC signaling(s)/parameter(s) CSI-ReportConfig and/or CSI-ResourceConfig, a list of RS/RS resource ID(s)/index(es); in this case, for a given RS/RS resource ID/index in the list, the RS or RS resource in the first (or second or third) set associated/configured with the given RS/RS resource ID/index could be associated, mapped or linked to the RS or RS resource in the second (or first or third) set associated/configured with the (same) given RS/RS resource ID/index and the RS or RS resource in the third (or first or second) set associated/configured with the (same) given RS/RS resource ID/index.
      UE's autonomous determination or selection, which could be further sent or transmitted to the network via various UL channels/signals such as CSI/beam report and/or UE's capability signaling(s)

For this design example, a RS or RS resource (in terms/form of its corresponding or respective RS/resource ID or index)—e.g., corresponding to the aforementioned first RS or RS resource—in the first set and its associated, mapped or linked RS or RS resource (in terms/form of its corresponding or respective RS/resource ID or index)—e.g., corresponding to the aforementioned second RS or RS resource—in the second set could respectively correspond to a sum beam (or a sum beam RS or RS resource) and a difference beam (or a difference beam RS or RS resource) according to or following those specified/defined herein in the present disclosure, or vice versa; alternatively, a RS or RS resource (in terms/form of its corresponding or respective RS/resource ID or index)—e.g., corresponding to the aforementioned first RS or RS resource—in the first set and its associated, mapped or linked RS or RS resource (in terms/form of its corresponding or respective RS/resource ID or index)—e.g., corresponding to the aforementioned third RS or RS resource—in the third set could respectively correspond to a sum beam (or a sum beam RS or RS resource) and a difference beam (or a difference beam RS or RS resource) according to or following those specified/defined herein in the present disclosure, or vice versa; optionally, a RS or RS resource (in terms/form of its corresponding or respective RS/resource ID or index)—e.g., corresponding to the aforementioned second RS or RS resource—in the second set and its associated, mapped or linked RS or RS resource (in terms/form of its corresponding or respective RS/resource ID or index)—e.g., corresponding to the aforementioned third RS or RS resource—in the third set could respectively correspond to a sum beam (or a sum beam RS or RS resource) and a difference beam (or a difference beam RS or RS resource) according to or following those specified/defined herein in the present disclosure, or vice versa. When/if a UE is indicated by the network, e.g., via/by a codepoint in a (unified) TCI state(s) activation/deactivation MAC CE and/or a TCI codepoint of a/the TCI field in a beam indication DCI (e.g., of DCI format(s) 1_1/1_2 with or without DL assignment), a TCI state; and when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned first set, the UE could then determine or identify that the determined or identified RS(s) or RS resource(s) could correspond to a sum (or difference) beam RS(s) or RS resource(s) as specified/defined herein in the present disclosure, and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned second set, the UE could then determine or identify that the determined or identified RS(s) or RS resource(s) could correspond to a difference (or sum) beam RS(s) or RS resource(s) as specified/defined herein in the present disclosure, and/or when/if the UE has determined or identified that the RS(s) or RS resource(s) associated with the TCI state (e.g., the QCL source RS(s) or RS resource(s) provided or configured in the higher layer parameter TCI-State that configures or provides the TCI state or the RS(s) or RS resource(s) e.g. SSB(s) that is QCL'ed—e.g., of QCL-TypeD—with the QCL source RS(s) or RS resource(s) provided or configured in the higher layer parameter TCI-State that configures or provides the TCI state) is from the aforementioned third set, the UE could then determine or identify that the determined or identified RS(s) or RS resource(s) could correspond to a difference (or sum) beam RS(s) or RS resource(s) as specified/defined herein in the present disclosure.

In this case, when/if the first RS or RS resource is associated with, e.g. indicated in/by, the first TCI state, the UE could identify or determine, based on or according to the fourth association/mapping relation, the second RS or RS resource and/or the third RS or RS resource. In addition, same/similar design considerations as in/to the fourth association/mapping relation as specified/described herein in the present disclosure can be applied/extended to the first, second and third association/mapping relations.

Furthermore, the second (or third) RS or RS resource could be (1) a CSI-RS resource/resource configuration provided in a CSI resource set configured with ‘repetition’ set to ‘on’, and/or a CSI resource set configured with ‘trs-Info’, e.g., when/if the first RS or RS resource is a CSI-RS resource/resource configuration as specified/defined in Scheme-1, or (2) a SSB, e.g., when/if the first RS or RS resource is a SSB as specified/defined in Scheme-2.
In another example, the first TCI state (and therefore, the first RS or RS resource) could be associated to a second TCI state and/or a third TCI state, wherein a second (or third) RS or RS resource could be associated with, e.g., indicated in/by, the second (or third) TCI state, and/or the first TCI state could be different/separate from the second TCI state and/or the third TCI state (e.g., in terms/form of their respective TCI state IDs/indexes), and/or the second RS or RS resource could be different or separate from the first RS or RS resource and/or the third RS or RS resource (e.g., in terms/form their respective RS/resource IDs/indexes); for this design example, the UE could determine or identify the association between the first TCI state (and therefore, the first RS or RS resource), the second TCI state (and therefore, the second RS or RS resource) and/or the third TCI state (and therefore, the third RS or RS resource) according to or following one or more of:
   For example, higher layer parameter(s)/signaling(s) e.g. TCI-State that provides or configures the first TCI state could also provide or configure or comprise or include or contain or indicate the second TCI state—e.g., in form/terms of the corresponding TCI state ID/index, and/or the third TCI state—e.g., in form/terms of the corresponding TCI state ID/index; alternatively, higher layer parameter(s)/signaling(s) e.g. TCI-State that provides or configures the second TCI state could also provide or configure or comprise or include or contain or indicate the first TCI state—e.g., in form/terms of the corresponding TCI state ID/index, and/or the third TCI state—e.g., in form/terms of the corresponding TCI state ID/index; optionally, higher layer parameter(s)/signaling(s) e.g. TCI-State that provides or configures the third TCI state could also provide or configure or comprise or include or contain or indicate the first TCI state—e.g., in form/terms of the corresponding TCI state ID/index, and/or the second TCI state—e.g., in form/terms of the corresponding TCI state ID/index; or, higher layer parameter(s)/signaling(s) e.g. TCI-State that provides or configures the first TCI state could also provide or configure or comprise or include or contain or indicate a first entity ID, higher layer parameter(s)/signaling(s) e.g. TCI-State that provides or configures the second TCI state could also provide or configure or comprise or include or contain or indicate a second entity ID, and/or higher layer parameter(s)/signaling(s) e.g. TCI-State that provides or configures the third TCI state could also provide or configure or comprise or include or contain or indicate a third entity ID, wherein the first, second and/or third entity IDs could be identical or same, or could have a/same value.

FIG. 13 illustrates an example of configuring or indicating a group of three TCI states for beam tracking 1300 according to embodiments of the present disclosure. The example of configuring or indicating a group of three TCI states for beam tracking 1300 as shown in FIG. 13 is for illustration only and other embodiments can be used without departing from the scope of the present disclosure.
For another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, a first association/mapping relation between the first and second TCI states (and therefore, between the first and second RSs/RS resources), a second association/mapping relation between the first and third TCI states (and therefore, between the first and third RSs/RS resources), a third association/mapping relation between the second and third TCI states (and therefore, between the second and third RSs/RS resources), and/or a fourth association/mapping relation between the first, second and third TCI states (and therefore, between the first, second and third RSs/RS resources):
   In one example, for the fourth association/mapping relation, the first, second and third TCI states—e.g., in terms/form of their TCI state IDs/indexes—could be provided or configured in/as a/the same list/set/pool, group and/or pair of TCI states (or TCI state IDs/indexes). In FIG. 13, a conceptual example of a beam group for tracking provided by a higher layer parameter beamGroupForTracking is presented, wherein the beam group for tracking characterizes the aforementioned fourth association/mapping relation.
   In another example, for the fourth association/mapping relation, the first, second and third TCI states—e.g., in terms/form of their TCI state IDs/indexes—could be provided or configured or activated or indicated in/by a/the same higher layer RRC signaling(s)/parameter(s) and/or MAC CE command(s) and/or dynamic DCI based L1 signaling(s).
   In another example, for the fourth association/mapping relation, the higher layer parameter(s)/signaling(s) that provides or configures the first TCI state e.g. TCI-State could also provide or configure a first entity ID, the higher layer parameter(s)/signaling(s) that provides or configures the second TCI state e.g. TCI-State could also provide or configure a second entity ID, and the higher layer parameter(s)/signaling(s) that provides or configures the third TCI state e.g. TCI-State could also provide or configure a third entity ID, wherein the first, second and third entity IDs could be identical or same, or could have a/same value.
   In another example, for the fourth association/mapping relation, the first TCI state e.g. in terms/form of the corresponding TCI state ID/index could be provided or configured in a first list/set/pool/group/pair of TCI state(s) or TCI state ID(s)/index(es) as/corresponding to the k-th entry in/of the first list/set/pool/group/pair, the second TCI state e.g. in terms/form of the corresponding TCI state ID/index could be provided or configured in a second list/set/pool/group/pair of TCI state(s) or TCI state ID(s)/index(es) as/corresponding to the 1-th entry in/of the second list/set/pool/group/pair, and the third TCI state e.g. in terms/form of the corresponding TCI state ID/index could be provided or configured in a third list/set/pool/group/pair of TCI state(s) or TCI state ID(s)/index(es) as/corresponding to the m-th entry in/of the third list/set/pool/group/pair, wherein k=1=m.
   In another example, for the fourth association/mapping relation, the UE could be provided or configured or indicated by the network, e.g., via higher layer RRC signaling(s)/parameter(s) and/or MAC CE command(s) and/or dynamic DCI based L1 signaling(s), a look-up table, wherein the first, second and third TCI states—e.g., in terms/form of their TCI state IDs/indexes—could correspond to three neighboring entries, or entries of three neighboring rows, or entries of three neighboring columns in the look-up table.
   In another example, for the fourth association/mapping relation, the first, second and third TCI states—e.g., in terms/form of their TCI state IDs/indexes—could be provided or configured in/as a/the same list/set/pool of TCI states (or TCI state IDs/indexes); for this design example, the first, second and third TCI states could be respectively associated to/with a first, a second and a third entity IDs (e.g., provided or configured in higher layer parameter(s)/signaling(s) that provides or configures the list/set/pool of TCI states/TCI state IDs/indexes), wherein the first, second and third entity IDs could be identical or same, or could have a/same value.

In this case, when/if the UE has received or indicated or updated by the network the first TCI state (hence the corresponding/associated first RS or RS resource), the UE could identify or determine, based on or according to the fourth association/mapping relation, the second TCI state (hence the corresponding/associated second RS or RS resource), and/or the third TCI state (hence the corresponding/associated third RS or RS resource). In addition, same/similar design considerations as in/to the fourth association/mapping relation as specified/described herein in the present disclosure can be applied/extended to the first, second and third association/mapping relations.

In particular, the second (or third) RS or RS resource could correspond to:
Scheme-i: a/the CSI-RS resource/resource configuration—e.g. served as a/the QCL source RS/RS resource—indicated in/by the second (or third) TCI state, wherein the CSI-RS resource/resource configuration could be provided in a CSI resource set configured with ‘repetition’ set to ‘on’, and/or a CSI resource set configured with ‘trs-Info’
Scheme-ii: a/the SSB quasi-co-located (QCL'ed)—e.g. of QCL-TypeD—with a/the QCL source RS/RS resource (e.g., corresponding to a/the aforementioned CSI-RS resource/resource configuration) indicated in/by the second (or third) TCI state

The UE could determine or identify the second (or third) RS or RS resource following Scheme-i or Scheme-ii based on or according to network's configuration(s)/indication(s)—e.g., Scheme-i or Scheme-ii is enabled for determining or identifying the second RS or RS resource—via higher layer RRC signaling(s)/parameter(s) and/or MAC CE command(s) and/or dynamic DCI based L1 signaling(s) according to or based on a corresponding UE's capability or capability signaling. Alternatively, or optionally, the second (or third) RS or RS resource could be (1) a CSI-RS resource/resource configuration provided in a CSI resource set configured with ‘repetition’ set to ‘on’, and/or a CSI resource set configured with ‘trs-Info’, e.g., when/if the first RS or RS resource is a CSI-RS resource/resource configuration as specified/defined in Scheme-1, or (2) a SSB, e.g., when/if the first RS or RS resource is a SSB as specified/defined in Scheme-2.

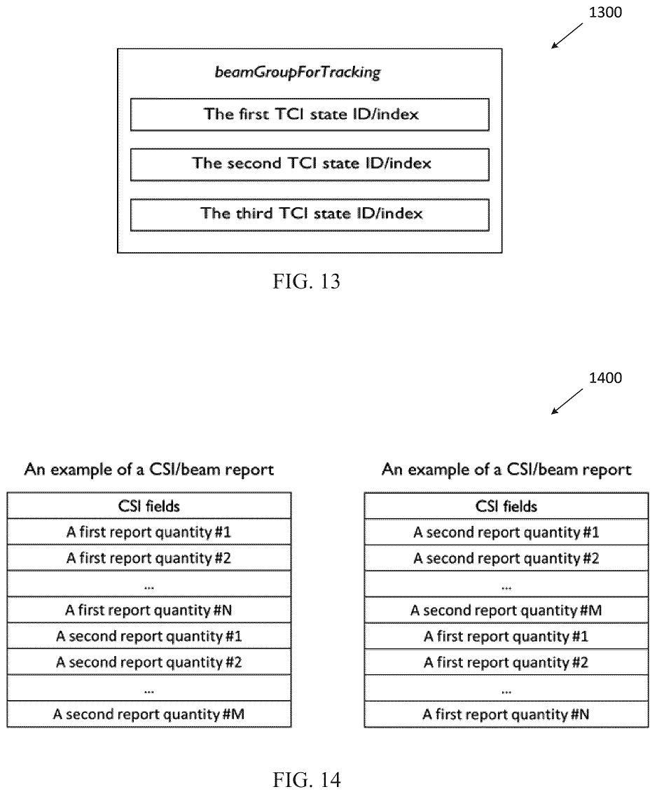

FIG. 14 illustrates an example CSI/beam report 1400 according to embodiments of the present disclosure. The example CSI/beam report 1400 as shown in FIG. 14 is for illustration only and other embodiments can be used without departing from the scope of the present disclosure.

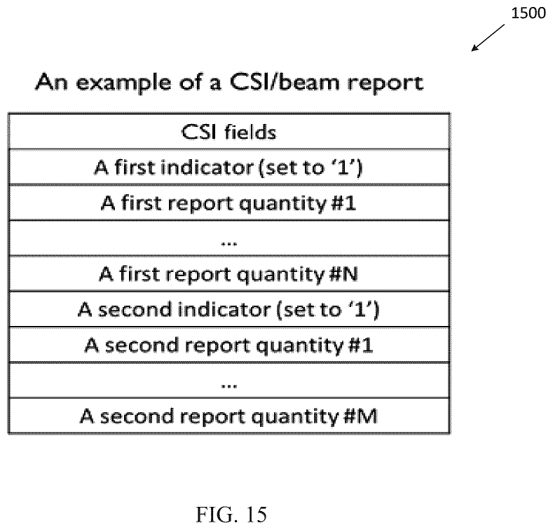

FIG. 15 illustrates another example CSI/beam report 1500 according to embodiments of the present disclosure. The example CSI/beam report 1500 as shown in FIG. 15 is for illustration only and other embodiments can be used without departing from the scope of the present disclosure.

According to or following those specified herein in the present disclosure,
In one example, the UE could determine or identify the aforementioned first RS or RS resource as a sum beam (or a sum beam RS or RS resource), and the aforementioned second RS or RS resource as a difference beam (or a difference beam RS or RS resource), or vice versa. The UE could then conduct the measurement and/or reporting procedure(s) with respect to or regarding the sum beam (hence the first RS or RS resource) and the difference beam (hence the second RS or RS resource) according to or following those specified herein in the present disclosure, and the UE may expect to receive from the network a corresponding response—e.g., a TCI state switching/update for beam tracking based on the reported measurement result(s)—according to or following those specified herein in the present disclosure.
In another example, the UE could determine or identify the aforementioned first RS or RS resource as a sum beam (or a sum beam RS or RS resource), and the aforementioned third RS or RS resource as a difference beam (or a difference beam RS or RS resource), or vice versa. The UE could then conduct the measurement and/or reporting procedure(s) with respect to or regarding the sum beam (hence the first RS or RS resource) and the difference beam (hence the third RS or RS resource) according to or following those specified herein in the present disclosure, and the UE may expect to receive from the network a corresponding response—e.g., a TCI state switching/update for beam tracking based on the reported measurement result(s)—according to or following those specified herein in the present disclosure.
In another example, the UE could determine or identify the aforementioned second (or third) RS or RS resource as a sum beam (or a sum beam RS or RS resource), and the aforementioned third (or second) RS or RS resource as a difference beam (or a difference beam RS or RS resource). The UE could then conduct the measurement and/or reporting procedure(s) with respect to or regarding the sum beam (hence the second (or third) RS or RS resource) and the difference beam (hence the third (or second) RS or RS resource) according to or following those specified herein in the present disclosure, and the UE may expect to receive from the network a corresponding response—e.g., a TCI state switching/update for beam tracking based on the reported measurement result(s)—according to or following those specified herein in the present disclosure.
In another example, the UE could determine or identify the aforementioned first RS or RS resource as a sum beam (or a sum beam RS or RS resource), and the aforementioned second RS or RS resource as a first difference beam (or a first difference beam RS or RS resource); the UE could then conduct the measurement and/or reporting procedure(s) with respect to or regarding the sum beam (hence the first RS or RS resource) and the first difference beam (hence the second RS or RS resource) according to or following those specified herein in the present disclosure, and obtain corresponding first measurement result(s) that can be reported in a CSI/beam report/reporting instance as first report quantity(s). Furthermore, the UE could determine or identify the aforementioned first RS or RS resource as a/the sum beam (or a/the sum beam RS or RS resource), and the aforementioned third RS or RS resource as a second difference beam (or a second difference beam RS or RS resource); the UE could then conduct the measurement and/or reporting procedure(s) with respect to or regarding the sum beam (hence the first RS or RS resource) and the second difference beam (hence the third RS or RS resource) according to or following those specified herein in the present disclosure, and obtain corresponding second measurement result(s) that can be reported in a CSI/beam report/reporting instance as second report quantity(s).
   For example, the UE could report, in a CSI/beam report or a reporting instance, both the first and second report quantities. The UE could determine or identify order(s) or ordering(s) or position(s) of the first and second report quantities in the CSI/beam report or the reporting instance according to or based on:
      Fixed rule(s) in system specification(s) and/or per RRC (re-)configuration. For instance, the (N≥1) CSI field(s) and the (M≥1) CSI field(s) used in a CSI/beam report or reporting instance to carry or convey the first and second report quantities respectively could be fixed (one conceptual example is presented in FIG. 14), wherein the value(s) of N and/or M could be provided or configured by the network e.g. via higher layer RRC signaling(s)/parameter(s) and/or MAC CE command(s) and/or dynamic DCI based L1 signaling(s) based on or according to a corresponding UE's capability or capability signaling.
      Network's configuration(s) and/or indication(s) e.g. via higher layer RRC signaling(s)/parameter(s) and/or MAC CE command(s) and/or dynamic DCI based L1 signaling(s) based on or according to a corresponding UE's capability or capability signaling. For instance, the UE could be provided or configured by the network a bitmap with each entry/bit position of the bitmap corresponding/associated to a report quantity in the CSI/beam report; when/if an entry/bit position of the bitmap is set to ‘1’ (or ‘0’), the report quantity corresponding/associated to the entry/bit position could correspond to a first report quantity, and when/if an entry/bit position of the bitmap is set to ‘0’ (or ‘1’), the report quantity corresponding/associated to the entry/bit position could correspond to a second report quantity. Alternatively, the UE could be configured or provided by the network, e.g. via higher layer RRC signaling(s)/parameter(s) CSI-ReportConfig, a/the higher layer parameter reportQuantity set to ‘firstAndsecond’, and/or the UE could be enabled or configured by the network, e.g., by setting a/the higher layer parameter reportQuantity in/via/by the higher layer RRC signaling(s)/parameter(s) CSI-ReportConfig to ‘firstAndsecond’, to report in a CSI/beam report or a reporting instance, at least resource indicators (SSBRI(s)/CRI(s)) and/or resource indexes for both the second and third RS or RS resources.
      UE's autonomous determination, which could be sent or indicated to the network via various UL channels/signals e.g. in part of the CSI/beam report, UE's capability signaling(s) and/or etc. For instance, as illustrated in FIG. 15, the CSI/beam report could comprise, include, contain or indicate a first indicator (e.g., present and/or set to ‘1’) carried or conveyed by a CSI field followed by CSI field(s) that carries or conveys the first report quantity(s), and a second indicator (e.g., present and/or set to ‘1’) carried or conveyed by a CSI field followed by CSI field(s) that carries or conveys the second report quantity(s). Alternatively, the CSI/beam report could comprise, include, contain or indicate a bitmap with each entry/bit position of the bitmap corresponding/associated to a report quantity in the CSI/beam report; when/if an entry/bit position of the bitmap is set to ‘1’ (or ‘0’), the report quantity corresponding/associated to the entry/bit position could correspond to a first report quantity, and when/if an entry/bit position of the bitmap is set to ‘0’ (or ‘1’), the report quantity corresponding/associated to the entry/bit position could correspond to a second report quantity. Optionally, the CSI/beam report could comprise, include, contain or indicate the resource indicator (e.g. SSBRI/CRI) or resource index corresponding to the second RS or RS resource carried or conveyed by a CSI field followed by CSI field(s) that carries or conveys the first report quantity(s), and the resource indicator (e.g., SSBRI/CRI) or resource index corresponding to the third RS or RS resource carried or conveyed by a CSI field followed by CSI field(s) that carries or conveys the second report quantity(s).
   For another example, the UE could report, in a CSI/beam report or a reporting instance, only the first report quantity(s) according to or based on:
      Fixed rule(s) in system specification(s) and/or per RRC (re-)configuration following one or more of: in one example, the beam metric e.g. the measured L1-RSRP for the second RS or RS resource (i.e., the first difference beam) is greater than or equal to that for the third RS or RS resource (i.e., the second difference beam); in another example, the beam metric e.g. the measured L1-RSRP for the second RS or RS resource (i.e., the first difference beam) is greater than that for the third RS or RS resource (i.e., the second difference beam) by a first threshold; in another example, the beam metric e.g. the measured L1-RSRP for the second RS or RS resource (i.e., the first difference beam) is greater than or equal to a second threshold, and/or the beam metric e.g. the measured L1-RSRP for the third RS or RS resource (i.e., the second difference beam) is less than or equal to a third threshold; in another example, the beam metric e.g. the measured L1-RSRP for the first RS or RS resource (i.e., the sum beam) is less (or greater) than or equal to a fourth threshold, and the beam metric e.g. the measured L1-RSRP for the second RS or RS resource (i.e., the first difference beam) is greater than or equal to a fifth threshold; in another example, the beam metric e.g. the measured L1-RSRP for the first RS or RS resource (i.e., the sum beam) is less (or greater) than or equal to the fourth threshold, and the beam metric e.g. the measured L1-RSRP for the third RS or RS resource (i.e., the second difference beam) is less than or equal to a sixth threshold; in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is less than or equal to a sixth threshold; in another example, the difference between the beam metric e.g. the measured L1-RSRP for the first RS or RS resource (i.e., the sum beam) and the beam metric e.g. the measured L1-RSRP for the third RS or RS resource (i.e., the second difference beam) is greater than or equal to a seven threshold; in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is less than or equal to the difference between the beam metric e.g. the measured L1-RSRP for the first RS or RS resource (i.e., the sum beam) and the beam metric e.g. the measured L1-RSRP for the third RS or RS resource (i.e., the second difference beam); in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is less than or equal to the difference between the beam metric e.g. the measured L1-RSRP for the first RS or RS resource (i.e., the sum beam) and the beam metric e.g. the measured L1-RSRP for the third RS or RS resource (i.e., the second difference beam) by an eighth threshold. The UE could determine or identify the first, second, third, fourth, fifth, sixth, seventh and/or eighth threshold(s) according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
      Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling. For instance, the UE could be provided or configured by the network, e.g., via higher layer RRC signaling(s)/parameter(s), a higher layer parameter reportQuantityType; when/if the higher layer parameter reportQuantityType is set to ‘first’, the UE could report, in a CSI/beam report or a reporting instance, only the first report quantity(s). Alternatively, the UE could be configured or provided by the network, e.g. via higher layer RRC signaling(s)/parameter(s) CSI-ReportConfig, a/the higher layer parameter reportQuantity set to ‘firstOnly’, and/or the UE could be enabled or configured by the network, e.g., by setting a/the higher layer parameter reportQuantity in/via/by the higher layer RRC signaling(s)/parameter(s) CSI-ReportConfig to ‘firstOnly’, to report in a CSI/beam report or a reporting instance, at least the resource indicator (SSBRI/CRI) and/or resource index for the second RS or RS resources.
      UE's autonomous determination, which could be sent or indicated to the network via various UL channels/signals e.g. in part of the CSI/beam report, UE's capability signaling(s) and/or etc. For instance, the CSI/beam report could comprise, include, contain or indicate a one-bit report quantity type indicator; in this case, when/if the report quantity type indicator is set to ‘1’ (or ‘0’), all the report quantity(s) in the CSI/beam report could correspond to the first report quantity(s). Optionally, the CSI/beam report could comprise, include, contain or indicate only the resource indicator (e.g. SSBRI/CRI) or resource index corresponding to the second RS or RS resource; in this case, all the report quantity(s) in the CSI/beam report could correspond to the first report quantity(s).
   For another example, the UE could report, in a CSI/beam report or a reporting instance, only the second report quantity(s) according to or based on:
      Fixed rule(s) in system specification(s) and/or per RRC (re-)configuration following one or more of: in one example, the beam metric e.g. the measured L1-RSRP for the second RS or RS resource (i.e., the first difference beam) is less than or equal to that for the third RS or RS resource (i.e., the second difference beam); in another example, the beam metric e.g. the measured L1-RSRP for the second RS or RS resource (i.e., the first difference beam) is less than that for the third RS or RS resource (i.e., the second difference beam) by a first threshold; in another example, the beam metric e.g. the measured L1-RSRP for the second RS or RS resource (i.e., the first difference beam) is less than or equal to a second threshold, and/or the beam metric e.g. the measured L1-RSRP for the third RS or RS resource (i.e., the second difference beam) is greater than or equal to a third threshold; in another example, the beam metric e.g. the measured L1-RSRP for the first RS or RS resource (i.e., the sum beam) is less (or greater) than or equal to a fourth threshold, and the beam metric e.g. the measured L1-RSRP for the second RS or RS resource (i.e., the first difference beam) is less than or equal to a fifth threshold; in another example, the beam metric e.g. the measured L1-RSRP for the first RS or RS resource (i.e., the sum beam) is less (or greater) than or equal to the fourth threshold, and the beam metric e.g. the measured L1-RSRP for the third RS or RS resource (i.e., the second difference beam) is greater than or equal to a sixth threshold; in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is greater than or equal to a sixth threshold; in another example, the difference between the beam metric e.g. the measured L1-RSRP for the first RS or RS resource (i.e., the sum beam) and the beam metric e.g. the measured L1-RSRP for the third RS or RS resource (i.e., the second difference beam) is less than or equal to a seven threshold; in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is greater than or equal to the difference between the beam metric e.g. the measured L1-RSRP for the first RS or RS resource (i.e., the sum beam) and the beam metric e.g. the measured L1-RSRP for the third RS or RS resource (i.e., the second difference beam); in another example, the difference between the beam metric e.g. the measured L1-RSRP for the first RS or RS resource (i.e., the sum beam) and the beam metric e.g. the measured L1-RSRP for the second RS or RS resource (i.e., the first difference beam) is greater than or equal to the difference between the beam metric e.g. the measured L1-RSRP for the first RS or RS resource (i.e., the sum beam) and the beam metric e.g. the measured L1-RSRP for the third RS or RS resource (i.e., the second difference beam) by an eighth threshold. The UE could determine or identify the first, second, third, fourth, fifth, sixth, seventh and/or eighth threshold(s) according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s).
      Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling. For instance, the UE could be provided or configured by the network, e.g., via higher layer RRC signaling(s)/parameter(s), a higher layer parameter reportQuantityType; when/if the higher layer parameter reportQuantityType is set to ‘second’, the UE could report, in a CSI/beam report or a reporting instance, only the second report quantity(s). Alternatively, the UE could be configured or provided by the network, e.g. via higher layer RRC signaling(s)/parameter(s) CSI-ReportConfig, a/the higher layer parameter reportQuantity set to ‘secondOnly’, and/or the UE could be enabled or configured by the network, e.g., by setting a/the higher layer parameter reportQuantity in/via/by the higher layer RRC signaling(s)/parameter(s) CSI-ReportConfig to ‘secondOnly’, to report in a CSI/beam report or a reporting instance, at least the resource indicator (SSBRI/CRI) and/or resource index for the third RS or RS resources.
      UE's autonomous determination, which could be sent or indicated to the network via various UL channels/signals e.g. in part of the CSI/beam report, UE's capability signaling(s) and/or etc. For instance, the CSI/beam report could comprise, include, contain or indicate a one-bit report quantity type indicator; in this case, when/if the report quantity type indicator is set to ‘0’ (or ‘1’), all the report quantity(s) in the CSI/beam report could correspond to the second report quantity(s). Optionally, the CSI/beam report could comprise, include, contain or indicate only the resource indicator (e.g. SSBRI/CRI) or resource index corresponding to the third RS or RS resource; in this case, all the report quantity(s) in the CSI/beam report could correspond to the second report quantity(s).

According to or following those specified or defined herein in the present disclosure, the UE could be provided or configured by the network, e.g., via higher layer RRC signaling(s)/parameter(s), a higher layer parameter reportQuantityType; in this case, when/if the higher layer parameter reportQuantityType is set to ‘first’, the UE could report, in a CSI/beam report or a reporting instance, only the first report quantity(s), when/if the higher layer parameter reportQuantityType is set to ‘second’, the UE could report, in a CSI/beam report or a reporting instance, only the second report quantity(s), and when/if the higher layer parameter reportQuantityType is set to ‘both’, the UE could report, in a CSI/beam report or a reporting instance, both the first and the second report quantities; furthermore, when/if the higher layer parameter reportQuantityType is absent or is not configured/present/provided in the corresponding higher layer RRC signaling(s)/parameter(s), the UE could report, in a CSI/beam report or a reporting instance,
only the first report quantity(s), or
only the second report quantity(s), or
both the first and second report quantities.
Optionally, the CSI/beam report could comprise, include, contain or indicate a report quantity type indicator; in this case, when/if the report quantity type indicator is set to ‘0’ (or ‘1’) or ‘00’ (or ‘01’ or ‘10’ or ‘11’), all the report quantity(s) in the CSI/beam report could correspond to the first report quantity(s), when/if the report quantity type indicator is set to ‘1’ (or ‘0’) or ‘01’ (or ‘00’ or ‘10’ or ‘11’), all the report quantity(s) in the CSI/beam report could correspond to the second report quantity(s), and when/if the report quantity type indicator is set to ‘10’ (or ‘00’ or ‘01’ or ‘11’ or ‘0’ or ‘1’), the report quantity(s) in the CSI/beam report could correspond to both the first and second report quantities; furthermore, when/if the report quantity type indicator is absent or is not indicated/present/provided in the corresponding CSI/beam report, the report quantity(s) in the CSI/beam report could correspond to,
only the first report quantity(s), or
only the second report quantity(s), or
both the first and second report quantities.

The UE may expect to receive from the network a corresponding response—e.g., a TCI state switching/update for beam tracking based on the reported measurement result(s) e.g. the first and/or second report quantity(s)—according to or following those specified herein in the present disclosure.
In another example, the UE could determine or identify the aforementioned first RS or RS resource as a sum beam (or a sum beam RS or RS resource), and the aforementioned second RS or RS resource as a first difference beam (or a first difference beam RS or RS resource); the UE could then conduct the measurement and/or reporting procedure(s) with respect to or regarding the sum beam (hence the first RS or RS resource) and the first difference beam (hence the second RS or RS resource) according to or following those specified herein in the present disclosure, and obtain corresponding first measurement result(s) that can be reported in a CSI/beam report/reporting instance as first report quantity(s). Furthermore, the UE could determine or identify the aforementioned first RS or RS resource as a/the sum beam (or a/the sum beam RS or RS resource), and the aforementioned third RS or RS resource as a second difference beam (or a second difference beam RS or RS resource); the UE could then conduct the measurement and/or reporting procedure(s) with respect to or regarding the sum beam (hence the first RS or RS resource) and the second difference beam (hence the third RS or RS resource) according to or following those specified herein in the present disclosure, and obtain corresponding second measurement result(s) that can be reported in a CSI/beam report/reporting instance as second report quantity(s). In addition, the UE could determine or identify the aforementioned second RS or RS resource as a sum (or difference) beam (or a sum (or difference) beam RS or RS resource), and the aforementioned third RS or RS resource as a difference (or sum) beam (or a difference (sum) beam RS or RS resource); the UE could then conduct the measurement and/or reporting procedure(s) with respect to or regarding the sum beam (hence the second (or third) RS or RS resource) and the difference beam (hence the third (or second) RS or RS resource) according to or following those specified herein in the present disclosure, and obtain corresponding third measurement result(s) that can be reported in a CSI/beam report/reporting instance as third report quantity(s). For this design example, the UE could determine or identify to report, in a CSI/beam report or a reporting instance, the first report quantity(s), the second report quantity(s) and/or the third report quantity(s) according to or based on those specified or described herein in the present disclosure—e.g., those specified or described for reporting the first and/or second report quantity(s) in the above design examples. When/if the UE report, in a CSI/beam report or a reporting instance, (i) both the first and second report quantities, (ii) both the first and third report quantities, (iii) both the second and third report quantities, or (iv) the first, second and third report quantities, the UE could determine or identify order(s) or ordering(s) or position(s) of the first, second and/or third report quantities in the CSI/beam report or the reporting instance according to or based on those specified or defined herein in the present disclosure—e.g., those specified or described for reporting the first and second report quantities in a CSI/beam report or a reporting instance. The UE may expect to receive from the network a corresponding response—e.g., a TCI state switching/update for beam tracking based on the reported measurement result(s) e.g. the first, second and/or third report quantity(s)—according to or following those specified herein in the present disclosure.

After a UE has sent or transmitted to the network, in a/the CSI/beam report or a/the reporting instance, the first, second and/or third report quantity(s) according to or following those specified herein in the present disclosure, the UE could expect to receive form the network a corresponding response e.g. (i) X symbol(s)/slot(s)/etc. after a last symbol/slot/etc. of transmission of the CSI/beam report, and/or (ii) within Y symbol(s)/slot(s)/etc. after a last symbol/slot/etc. of transmission of the CSI/beam report, wherein the UE could determine or identify value(s) of X and/or Y according to or based on: (i) fixed value(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s). Furthermore, the network's response could be in form of one or more of:
A one-bit ACK/NACK indicator
A TCI state update indicated e.g. via a codepoint of a (unified) TCI state(s) activation/deactivation MAC CE and/or a TCI codepoint of a/the TCI field in a beam indication DCI (e.g., DCI format(s) 1_1/1_2 with or without DL assignment)

When/if the network's response is indicated via a DCI, the network's response could be provided to the UE via a new/dedicated DCI field, or by repurposing one or more codepoints of one or more existing DCI fields in the corresponding DCI format(s).

The design examples specified or described herein in the present disclosure for the first and second RSs or RS resources could be extended or applied to case(s) when/if more than two RSs or RS resources are used as sum and difference beams for beam tracking. Furthermore, the design examples specified or described herein in the present disclosure for the first, second and third RSs or RS resources could be extended or applied to case(s) when/if more than three RSs or RS resources are used as sum and difference beams for beam tracking. A UE could conduct measurement(s) and reporting(s) for beam tracking via the sum and difference beams following those specified or defined or described herein in the present disclosure when/if the UE is provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, that the sum/difference beam(s) based beam tracking is enabled; for instance, when/if the UE is configured or provided by the network, e.g., via higher layer RRC signaling(s)/parameter(s), a higher layer parameter sumdiffBeamsForTracking and/or set to ‘enabled’, the UE could conduct measurement(s) and reporting(s) for beam tracking via the sum and difference beams following those specified or defined or described herein in the present disclosure; optionally, or alternatively, when/if the UE is configured or provided by the network, e.g., in/via/by higher layer RRC signaling(s)/parameter(s) e.g. in CSI-ReportConfig, the higher layer parameter reportQuantity set to ‘sumdiffBeamforTracking’, the UE could conduct measurement(s) and reporting(s) for beam tracking via the sum and difference beams following those specified or defined or described herein in the present disclosure. Throughout the present disclosure, the higher layer parameter/signaling CSI-ReportConfig is equivalent to the higher layer parameter/signaling CSI-ResourceConfig, and they can be used in an exchangeable manner.

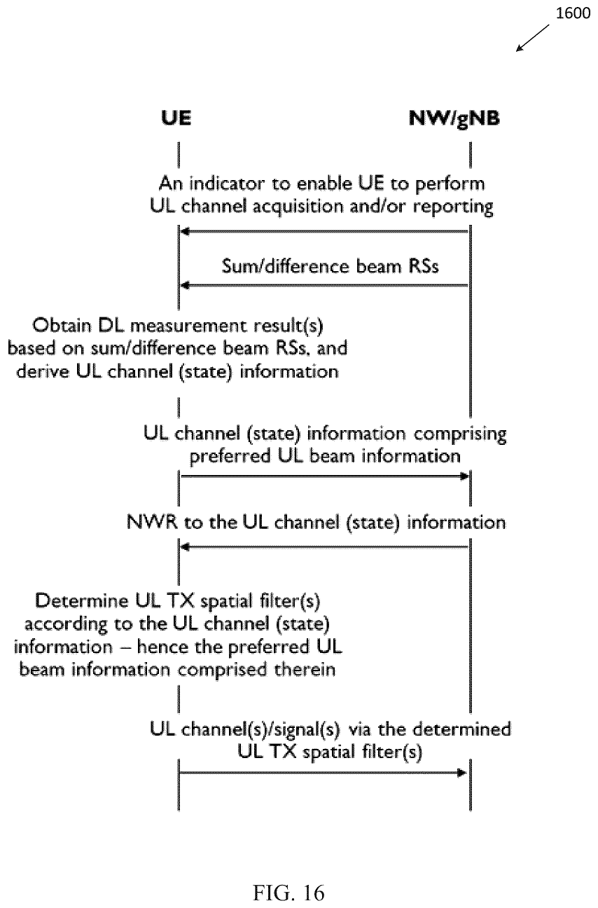

FIG. 16 illustrates an example procedure 1600 for UL channel acquisition via DL sum/difference beam RSs according to embodiments of the present disclosure. The example procedure 1600 for UL channel acquisition via DL sum/difference beam RSs as shown in FIG. 16 is for illustration only and other embodiments can be used without departing from the scope of the present disclosure.

According to or following those specified/defined herein in the present disclosure, a UE could be provided or configured or indicated by the network, e.g., via higher layer RRC signaling(s)/parameter(s) and/or MAC CE command(s) and/or dynamic DCI based L1 signaling(s) based on or according to corresponding UE's capability(s) and/or capability signaling(s), one or more indicators to enable the UE to perform or conduct uplink (UL) channel acquisition, and/or to report the acquired UL channel information to the network.
In one example, when/if the sum/difference beams based beam management/operation is enabled, configured, provided or indicated according to or following those specified/defined herein in the present disclosure, and/or when/if the UE has determined or identified to use or apply or follow the sum/difference beams based beam management/operation to perform measurement(s) and/or reporting(s) according to or following those specified/defined herein in the present disclosure, e.g., using or applying or following those specified/described in Method-1 and/or Method-2 to perform measurement(s) and/or reporting(s), the UE could perform/conduct uplink channel acquisition and/or report the acquired UL channel (state) information, if any, to the network or gNB.
In another example, the aforementioned one or more indicators could correspond to or could be in form of a higher layer parameter—e.g., denoted by sumDiffUplinkCh—provided or configured in higher layer RRC signaling(s)/parameter(s) e.g. CSI-ReportConfig that provides or configures necessary information and/or setting(s) for the sum/difference beams based beam management/operation. In this case, when/if the higher layer parameter sumDiffUplinkCh is provided or configured and/or set to ‘enabled’, the UE could perform/conduct uplink channel acquisition and/or report the acquired UL channel (state) information, if any, to the network or gNB.
In another example, when/if a/the higher layer parameter reportQuantity configured or provided in higher layer RRC signaling(s)/parameter(s) e.g. CSI-ReportConfig that provides or configures necessary information and/or setting(s) for the sum/difference beams based beam management/operation is set to ‘none’ or a special/particular/dedicated value e.g. ‘ul-channel-acquisition’, the UE could perform/conduct uplink channel acquisition and/or report the acquired UL channel (state) information, if any, to the network or gNB.

According to or following those specified/defined herein in the present disclosure, a UE could determine or identify a sum beam (or a sum beam RS/RS resource) based on or according to a first indicated TCI state (and therefore, a first RS or RS resource associated or specific or corresponding to the first indicated TCI state), and a difference beam (or a difference beam RS/RS resource) based on or according to a second indicated TCI state (and therefore, a second RS or RS resource associated or specific or corresponding to the second indicated TCI state), according to or based on: (i) fixed rule(s) in system specification(s) and/or per RRC (re-)configuration, (ii) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection or decision, which could be further sent or transmitted to the network via various UL channels/signals such as CSI/beam report and/or UE's capability signaling(s), wherein the first and second TCI states could be indicated by a (same) TCI codepoint via/by/in a (unified) TCI state(s) activation/deactivation MAC CE command and/or a/the TCI field of a beam indication DCI—e.g., of DCI format 1_1/1_2 with or without DL assignment. In this case, when/if the UE is provided or configured or indicated or enabled, by the network/gNB, to perform or conduct UL channel acquisition and/or to report the acquired UL channel information to the network/gNB according to or following those specified/defined herein in the present disclosure, the UE could (1) perform or conduct measurement(s) on the sum and difference beams (or the sum and difference beam RSs)—e.g. in form/terms of the first and second RSs provided or indicated or configured in the first and second indicated TCI states respectively, (2) obtain the corresponding (DL) measurement result(s)—e.g., L1-RSRP(s)/L1-SINR(s)—with respect to the sum beam RS and/or the difference beam RS, (3) derive, determine or identify UL channel (state) information—e.g., channels' AoA(s)/AoD(s)—according to or based on the (DL) measurement result(s) when/if reciprocity between the DL and UL channels—e.g., in terms or form of at least the channels' angular information such as AoA(s)/AoD(s)—is held, satisfied or achieved, and (4) report, in a reporting instance/CSI report/beam report, the derived, determined or identified UL channel (state) information comprising one or more of:
Report quantity (RQ)-1: An indicator to indicate whether the report content(s)/quantity(s) in the CSI/beam report could be for or specific to the UL channel (state) information; for instance, the indicator could correspond to or could be in form of a one-bit indicator: in this case, when/if the one-bit indicator is set to ‘1’ (or ‘0’), the report content(s)/quantity(s) in the CSI/beam report could be for or specific to the UL channel (state) information; otherwise, i.e., when/if the one-bit indicator is set to ‘0’ (or ‘1’), the report content(s)/quantity(s) in the CSI/beam report may not be for or specific to the UL channel (state) information—e.g., the report content(s)/quantity(s) in the CSI/beam report could be for or specific to the DL channel (state) information. Furthermore, presence or absence of the indicator in the corresponding CSI/beam report could be enabled (or disabled) and/or configured or provided or indicated by the network e.g. via higher layer RRC signalling(s)/parameter(s) based on or according to corresponding UE's capability(s) or capability signalling(s). When/if the indicator is absent from/in the CSI/beam report, the report content(s)/quantity(s) in the CSI/beam report may not be for or specific to the UL channel (state) information—e.g., the report content(s)/quantity(s) in the CSI/beam report could be for or specific to the DL channel (state) information
RQ-2: The aforementioned DL channel angle estimation result(s) B, which could be quantized to a x-bit value with y-bit step size, wherein the UE could be determine or identify the value(s) of x and/or y according to or based on: (1) fixed value(s) in system specification(s) and/or per RRC (re-)configuration, (2) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection or decision, which could be further sent or transmitted to the network via various UL channels/signals such as CSI/beam report and/or UE's capability signaling(s)
RQ-3: Index of the aforementioned DL channel angle estimation result(s) \hat{θ} determined or selected from a set (or codebook) of candidate DL channel angle value(s)
RQ-4: An UL channel angle estimation result(s) \hat{θ}′ derived or determine or identified according to or based on the DL channel angle estimation result(s) \hat{θ} e.g. based on or according to DL and UL channels' reciprocities, which could be quantized to a x′-bit value with y′-bit step size, wherein the UE could be determine or identify the value(s) of x′ and/or y′ according to or based on: (1) fixed value(s) in system specification(s) and/or per RRC (re-)configuration, (2) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection or decision, which could be further sent or transmitted to the network via various UL channels/signals such as CSI/beam report and/or UE's capability signaling(s)
RQ-5: Index of the aforementioned UL channel angle estimation result(s) \hat{θ}′ determined or selected from a set (or codebook) of candidate UL channel angle value(s)
RQ-6: A set of one or more candidate joint/UL TCI states—e.g., in terms/form of the corresponding TCI state ID(s)/index(es) determined or identified or selected or configured or provided from a list/set/pool of joint/UL TCI state(s)/TCI state ID(s)/index(es) higher layer configured or provided to the UE—for joint/UL TCI state(s) activation/deactivation
RQ-7: A set of one or more candidate joint/UL TCI states—e.g., in terms/form of the corresponding TCI state ID(s)/index(es) determined or identified or selected or configured or provided from the joint/UL TCI state(s) activated or indicated by/in a/the (unified) TCI state(s) activation/deactivation MAC CE command
for joint/UL beam(s)/TCI state(s) activation/deactivation
RQ-8: A set of one or more candidate TCI codepoints each mapped to one or more (candidate) joint/UL TCI state—e.g., in terms/form of the corresponding TCI codepoint index(es) determined or identified or selected or configured or provided or indicated from the TCI codepoint(s) activated or indicated in/by a/the (unified) TCI state(s) activation/deactivation MAC CE command—for joint/UL TCI state(s) activation/deactivation
RQ-9: One or more preferred joint/UL TCI states for TCI state(s) indication/update—e.g., in terms/form of the corresponding TCI state ID(s)/index(es)—determined or identified or selected or provided or configured or indicated from/in/by one or more of:
   A list/set/pool of joint/UL TCI state(s)/TCI state ID(s)/index(es) higher layer configured or provided to the UE
   The aforementioned set of one or more candidate joint/UL TCI states for joint/UL TCI state(s) activation/deactivation
   The joint/UL TCI state(s) activated or indicated by/in a/the (unified) TCI state(s) activation/deactivation MAC CE command
RQ-10: One or more preferred TCI codepoints each mapped to one or more (preferred) joint/UL TCI states for TCI state(s) indication/update—e.g., in terms/form of the corresponding TCI codepoint index(es)—determined or identified or selected or provided or configured or indicated from/in/by one or more of:
   The aforementioned set of one or more candidate TCI codepoints for joint/UL TCI state(s) activation/deactivation
   The TCI codepoint(s)—mapped to one or more joint/UL TCI states for joint/UL TCI state(s) activation/deactivation—activated or indicated by/in a/the (unified) TCI state(s) activation/deactivation MAC CE command
RQ-11: A set of one or more candidate RS resources—e.g., in terms/form of the corresponding RS resource (configuration) index(es)/ID(s) and/or resource indicator(s) such as SSBRI(s)/CRI(s) determined or identified or selected or configured or provided from a list/set/pool of RS resource (configuration) index(es)/ID(s) higher layer configured or provided to the UE—for joint/UL beam(s)/TCI state(s) activation/deactivation
RQ-12: A set of one or more candidate RS resources—e.g., in terms/form of the corresponding RS resource (configuration) index(es)/ID(s) and/or resource indicator(s) such as SSBRI(s)/CRI(s) determined or identified or selected or configured or provided from the RS(s) or RS resource(s) associated, specific or corresponding to the joint/UL TCI state(s) activated or indicated by/in a/the (unified) TCI state(s) activation/deactivation MAC CE command—for joint/UL beam(s)/TCI state(s) activation/deactivation
RQ-13: One or more preferred RS resources for joint/UL TCI state(s) indication/update—e.g., in terms/form of the corresponding RS resource (configuration) index(es)/ID(s) and/or resource indicator(s) such as SSBRI(s)/CRI(s)—determined or identified or selected or provided or configured or indicated from/in/by one or more of:
   A list/set/pool of RS resource (configuration) index(es)/ID(s) higher layer configured or provided to the UE
   The aforementioned set of one or more candidate RS resources for joint/UL beam(s)/TCI state(s) activation/deactivation
   The RS(s) or RS resource(s) associated, specific or corresponding to the joint/UL TCI state(s) activated or indicated by/in a/the (unified) TCI state(s) activation/deactivation MAC CE command
RQ-14: Resource indicator (SSBRI/CRI) of the first RS/RS resource and/or the beam metric (L1-RSRP/L1-SINR) corresponding to the first RS/RS resource
RQ-15: Resource indicator (SSBRI/CRI) of the second RS/RS resource and/or the beam metric (L1-RSRP/L1-SINR) corresponding to the second RS/RS resource
RQ-16: Channel state information (CSI) report for the first RS/RS resource
RQ-17: Channel state information (CSI) report for the second RS/RS resource

Optionally, the reporting instance, CSI report or beam report could comprise two-part: part 1 of the two-part UCI/CSI could comprise RQ-1 and/or one or more of: number(s)/payload size(s) of RQ-2 in the reporting instance/CSI report/beam report, number(s)/payload size(s) of RQ-3 in the reporting instance/CSI report/beam report, number(s)/payload size(s) of RQ-4 in the reporting instance/CSI report/beam report, . . . , and/or number(s)/payload size(s) of RQ-17 in the reporting instance/CSI report/beam report, while part 2 of the two-part UCI could comprise one or more of: RQ-2, RQ-3, RQ-4, . . . , and/or RQ-17 as specified/defined herein in the present disclosure. Part 1 of the two-part UCI/CSI could be present or absent based on or according to network's configuration(s)/indication(s) e.g. via higher layer RRC signaling(s)/parameter(s) and/or MAC CE command(s) and/or dynamic DCI based L1 signaling(s) based on or according to corresponding UE's capability(s)/capability signaling(s). When/if part 1 is absent, the reporting instance, CSI report or beam report could be in form of one-part UCI/CSI comprising one or more of: number(s)/payload size(s) of RQ-1 in the reporting instance/CSI report/beam report, number(s)/payload size(s) of RQ-2 in the reporting instance/CSI report/beam report, number(s)/payload size(s) of RQ-3 in the reporting instance/CSI report/beam report, number(s)/payload size(s) of RQ-4 in the reporting instance/CSI report/beam report, . . . , and/or number(s)/payload size(s) of RQ-17 in the reporting instance/CSI report/beam report, RQ-1, RQ-2, RQ-3, RQ-4, . . . , and/or RQ-17 as specified/defined herein in the present disclosure.

According to or following those specified or defined herein in the present disclosure, after the UE has transmitted or sent to the network the CSI/beam report that comprises the derived, determined or identified UL channel (state) information,
In one example, the UE may expect to receive a network response (NWR) to the CSI/beam report (hence the reported UL channel (state) information), or more specifically, to the UE reporting initiated or triggered beam(s)/TCI state(s) switching or update,
   no earlier than X1 symbol(s)/slot(s)/etc. and/or no later than X2 symbol(s)/slot(s)/etc. starting from or after a last (or first) symbol/slot/etc. of the UL resource(s) such as PUCCH/PUSCH resource(s) that carries or conveys the UL channel (state) information, or
   starting from a/the first symbol/slot/etc. that is at least X3 symbol(s)/slot(s) after a/the last (or first) symbol/slot/etc. of the UL resource(s) such as PUCCH/PUSCH resource(s) that carries or conveys the UL channel (state) information.

For this design example, the NWR could correspond to or could be in form of:
A one-bit ACK/NACK indicator in response to a/the reported UL channel (state) information comprising e.g. one or more preferred joint/UL TCI states in form of the corresponding TCI state ID(s)/index(es) for joint/UL TCI state(s) indication/update, one or more preferred RS resources in form the corresponding RS resource (configuration) ID(s)/index(es) for joint/UL TCI state(s) indication/update and/or etc.
One or more joint/UL TCI states—e.g., activated/indicated by one or more TCI codepoints in/of a (unified) TCI state(s) activation/deactivation MAC CE command and/or a/the TCI field of a/the beam indication DCI e.g. of format(s) 1_1/1_2 with or without DL assignment—in terms/form the corresponding TCI state ID(s)/index(es), wherein the corresponding TCI state ID(s)/index(es) could be from or a subset of the set of one or more candidate joint/UL TCI states (in terms/form the corresponding TCI state ID(s)/index(es)) reported for joint/UL TCI state(s) activation/deactivation; in this case,
   for example, each of the one or more joint/UL TCI states could have a/the same TCI state ID/index as that of a preferred joint/UL TCI state—determined or identified or selected according to or following those specified/defined herein in the present disclosure—reported in (part of) the CSI/beam report for joint/UL TCI state(s) indication/update according to or following those specified herein in the present disclosure;
   for another example, each of the one or more joint/UL TCI states could be mapped to a preferred TCI codepoint—determined or identified or selected according to or following those specified/defined herein in the present disclosure—reported (e.g., in terms/form of the corresponding TCI codepoint index) in (part of) the CSI/beam report for joint/UL TCI state(s) indication/update according to or following those specified herein in the present disclosure;
   for another example, the RS(s) or RS resource(s) associated or specific to each of the one or more joint/UL TCI states could be configured with or could have a/the same RS/resource ID(s)/index(es) as the preferred RS(s) or RS resource(s)—determined or identified or selected according to or following those specified/defined herein in the present disclosure—reported in (part of) the CSI/beam report for joint/UL TCI state(s) indication/update according to or following those specified herein in the present disclosure;
   for another example, the RS(s) or RS resource(s) associated or specific to each of the one or more joint/UL TCI states could be configured with or could have a/the same RS/resource ID(s)/index(es) as the RS(s) or RS resource(s) associated or specific to a preferred joint/UL TCI state—determined or identified or selected according to or following those specified/defined herein in the present disclosure—reported in (part of) the CSI/beam report for joint/UL TCI state(s) indication/update according to or following those specified herein in the present disclosure.

Here, the one or more indicated joint/UL TCI states could be considered, treated or interpreted as network's ACK(s) to the reported preferred joint/UL TCI state(s), preferred TCI codepoint(s) and/or preferred RS(s)/RS resource(s) for joint/UL TCI state(s)/beam(s) indication/update.
One or more joint/UL TCI states—e.g., indicated by one or more TCI codepoints in/of a/the TCI field of a/the beam indication DCI e.g. of format(s) 11/1_2 with or without DL assignment—in terms/form the corresponding TCI state ID(s)/index(es), wherein the one or more TCI codepoints could be from or could correspond to a subset of the set of one or more candidate TCI codepoints reported for joint/UL TCI state(s) activation/deactivation, and the corresponding TCI state ID(s)/index(es) could be from or a subset of the set of one or more candidate joint/UL TCI states (in terms/form the corresponding TCI state ID(s)/index(es)) reported for joint/UL TCI state(s) activation/deactivation; in this case,
   for example, each of the one or more joint/UL TCI states could have a/the same TCI state ID/index as that of a preferred joint/UL TCI state—determined or identified or selected according to or following those specified/defined herein in the present disclosure—reported in (part of) the CSI/beam report for joint/UL TCI state(s) indication/update according to or following those specified herein in the present disclosure;
   for another example, each of the one or more joint/UL TCI states could be mapped to a preferred TCI codepoint—determined or identified or selected according to or following those specified/defined herein in the present disclosure—reported (e.g., in terms/form of the corresponding TCI codepoint index) in (part of) the CSI/beam report for joint/UL TCI state(s) indication/update according to or following those specified herein in the present disclosure;
   for another example, the RS(s) or RS resource(s) associated or specific to each of the one or more joint/UL TCI states could be configured with or could have a/the same RS/resource ID(s)/index(es) as the preferred RS(s) or RS resource(s)—determined or identified or selected according to or following those specified/defined herein in the present disclosure—reported in (part of) the CSI/beam report for joint/UL TCI state(s) indication/update according to or following those specified herein in the present disclosure;
   for another example, the RS(s) or RS resource(s) associated or specific to each of the one or more joint/UL TCI states could be configured with or could have a/the same RS/resource ID(s)/index(es) as the RS(s) or RS resource(s) associated or specific to a preferred joint/UL TCI state—determined or identified or selected according to or following those specified/defined herein in the present disclosure—reported in (part of) the CSI/beam report for joint/UL TCI state(s) indication/update according to or following those specified herein in the present disclosure.

Here, the one or more indicated joint/UL TCI states could be considered, treated or interpreted as network's ACK(s) to the reported preferred joint/UL TCI state(s), preferred TCI codepoint(s) and/or preferred RS(s)/RS resource(s) for joint/UL TCI state(s)/beam(s) indication/update.
One or more RSs or RS resources in terms/form the corresponding RS/resource ID(s)/index(es), wherein the one or more RSs or RS resources could be from or could correspond to a subset of the set of one or more candidate RSs or RS resources reported for joint/UL TCI state(s) activation/deactivation: in this case,
   for example, each of the one or more RSs or RS resources could be configured with or could have a/the same RS/resource ID/index as a preferred RS or RS resource—determined or identified or selected according to or following those specified/defined herein in the present disclosure—reported in (part of) the CSI/beam report for joint/UL TCI state(s) indication/update according to or following those specified herein in the present disclosure;
   for another example, each of the one or more RSs or RS resources could be configured with or could have a/the same RS/resource ID/index as the RS or RS resource associated or specific to a preferred TCI state—determined or identified or selected according to or following those specified/defined herein in the present disclosure—reported in (part of) the CSI/beam report for joint/UL TCI state(s) indication/update according to or following those specified herein in the present disclosure;
   for another example, the TCI state associated or specific to each of the one or more RSs or RS resources could have a/the same TCI state ID/index as that of a preferred TCI state—determined or identified or selected according to or following those specified/defined herein in the present disclosure—reported in (part of) the CSI/beam report for joint/UL TCI state(s) indication/update according to or following those specified herein in the present disclosure.

Here, the one or more indicated RSs/RS resources could be considered, treated or interpreted as network's ACK(s) to the reported preferred joint/UL TCI state(s), preferred TCI codepoint(s) and/or preferred RS(s)/RS resource(s) for joint/UL TCI state(s)/beam(s) indication/update.
A bitmap having the same number of entries/bit positions as the number of reported beams—e.g., in terms/form of the preferred TCI state(s), preferred TCI codepoint(s) and/or preferred RS(s)/RS resource(s) reported in the CSI/beam report—for the joint/UL beam(s)/TCI state(s) indication/update; each of the entries/bit positions in/of the bitmap could be associated or corresponding to a reported beam—e.g., in terms/form of a preferred TCI state, a preferred TCI codepoint and/or a preferred RS/RS resource—in (part of) the beam/CSI report and/or the corresponding UL channel (state) information for the joint/UL beam(s)/TCI state(s) indication or update according to or following those specified herein in the present disclosure; in this case, when/if an entry/bit position of the bitmap is set to ‘1’ (or ‘0’), the entry/bit position could act or serve or could be considered/regarded as a one-bit ACK (or NACK) indicator in response to the reported beam associated or corresponding to the entry/bit position for the joint/UL beam(s)/TCI state(s) update or indication according to or following those specified herein in the present disclosure.
One or more index values: each of the one or more index values could correspond to a position or ordering or order or index of a reported beam—e.g., in terms/form of the preferred TCI state(s), preferred TCI codepoint(s) and/or preferred RS(s)/RS resource(s) reported in the CSI/beam report—among all the reported beams—e.g., in terms/form of their corresponding preferred TCI states, preferred TCI codepoints and/or preferred RSs/RS resources reported in the CSI/beam report—in (part of) the beam/CSI report and/or the corresponding UL channel (state) information for the joint/UL beam(s)/TCI state(s) indication/update according to or following those specified herein in the present disclosure, or among all the reported beams—e.g., in terms/form of their corresponding preferred TCI states, preferred TCI codepoints and/or preferred RSs/RS resources reported in the CSI/beam report—in (part of) the beam/CSI report and/or the corresponding UL channel (state) information for the joint/UL beam(s)/TCI state(s) indication/update according to or following those specified herein in the present disclosure; in this case, each of the one or more index values could act or serve or could be considered or regarded as an ACK in response to a corresponding/associated reported beam—e.g., in terms/form of the preferred TCI state(s), preferred TCI codepoint(s) and/or preferred RS(s)/RS resource(s) reported in the CSI/beam report—in (part of) the beam/CSI report and/or the corresponding UL channel (state) information for the joint/UL beam(s)/TCI state(s) indication/update according to or following those specified herein in the present disclosure.

The UE could determine or identify value(s) of X1, X2 and/or X3 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig that provides or configures necessary information and/or resource and/or reporting setting(s) for the sum/difference beams based beam management/operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Additionally, the UE could apply the TCI state(s)
having same TCI state ID(s)/index(es) as that/those of the joint/UL TCI state(s) (i) reported (as or in terms/form of preferred TCI state(s), preferred TCI codepoint(s), and/or preferred RS(s)/RS resource(s)) in (part of) the beam/CSI report and/or the corresponding UL channel (state) information for the joint/UL beam(s)/TCI state(s) indication/update according to or following those specified herein in the present disclosure, and (ii) acknowledged or ACK'ed by the network via a corresponding NWR according to or following those specified herein in the present disclosure;
associated, specific or corresponding to the RS(s) or RS resource(s), (i) reported (as or in terms/form of preferred TCI state(s), preferred TCI codepoint(s), and/or preferred RS(s)/RS resource(s)) in (part of) the beam/CSI report and/or the corresponding UL channel (state) information for the joint/UL beam(s)/TCI state(s) indication/update according to or following those specified herein in the present disclosure, and (ii) acknowledged or ACK'ed by the network via a corresponding NWR according to or following those specified herein in the present disclosure;
according to or following one or more of:
no earlier than Y1 symbol(s)/slot(s) and/or no later than Y2 symbol(s)/slot(s) after a/the last (or first) symbol/slot/etc. of receiving or reception of the NWR
starting from a/the first symbol/slot/etc. that is at least Y3 symbol(s)/slot(s) after a/the last (or first) symbol/slot/etc. of receiving or reception of the NWR
no earlier than Y4 symbol(s)/slot(s) and/or no later than Y5 symbol(s)/slot(s) after a/the last (or first) symbol/slot/etc. of transmitting or transmission(s) of PUCCH(s) and/or PUSCH(s) with positive HARQ-ACK corresponding to the NWR
starting from a/the first symbol/slot/etc. that is at least Y6 symbol(s)/slot(s) after a/the last (or first) symbol/slot/etc. of transmitting or transmission(s) of PUCCH(s) and/or PUSCH(s) with positive HARQ-ACK corresponding to the NWR,
to determine or identify or set UL TX spatial filter(s) for transmitting at least dynamic-grant and configured-grant based PUSCH and PUCCH, and for SRS applying the indicated TCI state. The UE could determine or identify value(s) of Y1, Y2, Y3, Y4, Y5 and/or Y6 according to or based on: (i) fixed value(s) in system specification(s) and/or per RRC (re-)configuration, (ii) network's configuration(s)/indication(s) via higher layer RRC signaling(s)/parameter(s) e.g. CSI-ReportConfig that provides or configures necessary information and/or resource and/or reporting setting(s) for the sum/difference beams based beam management/operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. When/if the NWR is indicated in/via/by a DCI based L1 signaling, the corresponding DCI can be a downlink DCI of format 1_0, 1_3, 1_1 and/or 1_2 with or without DL assignment, an uplink DCI of format 0_0, 0_3, 0_1 and/or 0_2 with or without UL grant, or a dedicated DCI format for TCI state(s) indication, switching and/or update. Furthermore,
The dedicated DCI format—denoted by TCI-DCI format—could comprise at least a TCI field indicating TCI codepoint(s) mapped to one or more joint, DL and/or UL TCI states according to or following those specified/defined herein in the present disclosure for the unified TCI framework and its extensions; in this case, the dedicated TCI-DCI format could be or could correspond to the NWR itself (e.g., act or serve as an ACK/NACK indicator in response to the reported UL channel (state) information), or the NWR could correspond to a dedicated DCI field in the dedicated TCI-DCI format, or the NWR could be realized or implemented in the dedicated TCI-DCI format by repurposing one or more codepoints of one or more existing DCI fields such as the TCI field in the dedicated TCI-DCI format. Optionally, when/if the NWR corresponds to an ACK/NACK in response to the reported UL channel (state) information, the ACK/NACK can be implicit based on or according to e.g.: (a) presence/absence of one or more DCI fields in the corresponding DCI format, and/or (b) indicating one or more particular codepoints of one or more DCI fields in the corresponding DCI format—the UE could determine or identify the one or more particular codepoints according to or based on: (i) fixed value(s)/rule(s) in system specification(s) and/or per RRC (re-)configuration, (ii) network's configuration(s)/indication(s) via higher layer RRC signaling(s)/parameter(s) e.g. CSI-ReportConfig that provides or configures necessary information and/or resource and/or reporting setting(s) for the sum/difference beams based beam management/operations and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling(s);
The dedicated DCI format—denoted by UL-TCI-DCI format—could comprise at least a TCI field indicating TCI codepoint(s) mapped to one or more joint and/or UL TCI states according to or following those specified/defined herein in the present disclosure for the unified TCI framework and its extensions; in this case, the dedicated UL-TCI-DCI format could be or could correspond to the NWR itself (e.g., act or serve as an ACK/NACK indicator in response to the reported UL channel (state) information), or the NWR could correspond to a dedicated DCI field in the dedicated UL-TCI-DCI format, or the NWR could be realized or implemented in the dedicated UL-TCI-DCI format by repurposing one or more codepoints of one or more existing DCI fields such as the TCI field in the dedicated UL-TCI-DCI format. Optionally, when/if the NWR corresponds to an ACK/NACK in response to the reported UL channel (state) information, the ACK/NACK can be implicit based on or according to e.g.: (a) presence/absence of one or more DCI fields in the corresponding DCI format, and/or (b) indicating one or more particular codepoints of one or more DCI fields in the corresponding DCI format—the UE could determine or identify the one or more particular codepoints according to or based on: (i) fixed value(s)/rule(s) in system specification(s) and/or per RRC (re-)configuration, (ii) network's configuration(s)/indication(s) via higher layer RRC signaling(s)/parameter(s) e.g. e.g. CSI-ReportConfig that provides or configures necessary information and/or resource and/or reporting setting(s) for the sum/difference beams based beam management/operations and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling(s);
When/if the NWR is indicated in/via/by a downlink DCI of format 10, 1_3, 1_1 and/or 1_2 with or without DL assignment, and/or an uplink DCI of format 00, 0_3, 0_1 and/or 0_2 with or without UL grant, the NWR could correspond to a new/dedicated DCI field in the corresponding DCI format(s)—e.g. a new/dedicated TCI field in an uplink DCI format indicating TCI codepoint(s) that can be mapped to at least one or more UL TCI states according to or following those specified or defined herein in the present disclosure, or the NWR could be realized or implemented by repurposing one or more codepoints of one or more existing DCI fields such as the TCI field in the corresponding DCI format(s)—e.g., a DL DCI format. Optionally, when/if the NWR corresponds to an ACK/NACK in response to the reported UL channel (state) information, the ACK/NACK can be implicit based on or according to e.g.: (a) presence/absence of one or more DCI fields in the corresponding DCI format, and/or (b) indicating one or more particular codepoints of one or more DCI fields in the corresponding DCI format—the UE could determine or identify the one or more particular codepoints according to or based on: (i) fixed value(s)/rule(s) in system specification(s) and/or per RRC (re-)configuration, (ii) network's configuration(s)/indication(s) via higher layer RRC signaling(s)/parameter(s) e.g. CSI-ReportConfig that provides or configures necessary information and/or resource and/or reporting setting(s) for the sum/difference beams based beam management/operations as specified/defined herein in the present disclosure and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling(s).
In another example, the UE may not expect to receive any NWR(s) to the CSI/beam report hence the corresponding UL channel (state) information. In this case, the UE could apply the TCI state(s)
having same TCI state ID(s)/index(es) as that/those of the joint/UL TCI state(s) reported (as or in terms/form of preferred TCI state(s), preferred TCI codepoint(s), and/or preferred RS(s)/RS resource(s)) in (part of) the beam/CSI report and/or the corresponding UL channel (state) information for the joint/UL beam(s)/TCI state(s) indication/update according to or following those specified herein in the present disclosure;
associated, specific or corresponding to the RS(s) or RS resource(s) reported (as or in terms/form of preferred TCI state(s), preferred TCI codepoint(s), and/or preferred RS(s)/RS resource(s)) in (part of) the beam/CSI report and/or the corresponding UL channel (state) information for the joint/UL beam(s)/TCI state(s) indication/update according to or following those specified herein in the present disclosure,
according to or following one or more of:
starting from a/the first symbol/slot/etc. that is at least Z1 symbol(s)/slot(s) after a/the last (or first) symbol/slot/etc. of the UL resource(s) including PUCCH/PUSCH resource(s) used or applied to transmit or send the CSI/beam report and/or the corresponding UL channel (state) information as specified/defined herein in the present disclosure
no earlier than Z2 symbol(s)/slot(s) and/or no later than Z3 symbol(s)/slot(s) after a/the last (or first) symbol/slot/etc. of the UL resource(s) including PUCCH/PUSCH resource(s) used or applied to transmit or send the CSI/beam report and/or the corresponding UL channel (state) information as specified/defined herein in the present disclosure,
to determine or identify or set UL TX spatial filter(s) for transmitting at least dynamic-grant and configured-grant based PUSCH and PUCCH, and for SRS applying the indicated TCI state. The UE could determine or identify value(s) of Z1, Z2 and/or Z3 according to or based on: (i) fixed value(s) in system specification(s) and/or per RRC (re-)configuration, (ii) network's configuration(s)/indication(s) via higher layer RRC signaling(s)/parameter(s) e.g. e.g. CSI-ReportConfig that provides or configures necessary information and/or resource and/or reporting setting(s) for the sum/difference beams based beam management/operations and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A conceptual example characterizing the above-described design procedure(s) is presented in FIG. 16.

Throughout the present disclosure, for the L1-RSRP reporting corresponding to the first (or second) RS/RS resource—or equivalently the same (or difference) beam RS/RS resource, the reported L1-RSRP value could correspond to
the exact measured L1-RSRP value, and/or
a 7-bit value in the range [−140, −44] dBm with 1 dB step size,
a 4-bit quantized value with 2 dB step size with a reference to the largest measured L1-RSRP value, e.g., in the same part of the L1-RSRP reporting instance.

Throughout the present disclosure, for the L1-SINR reporting corresponding to the first (or second) RS/RS resource—or equivalently the same (or difference) beam RS/RS resource, the reported L1-RSRP value could correspond to
the exact measured L1-SINR value, and/or
a 7-bit value in the range [−23, 40] dB with 0.5 dB step size,
a 4-bit quantized value with 1 dB step size with a reference to the largest measured L1-SINR value, e.g., in the same part of the L1-SINR reporting instance.

Throughout the present disclosure, a TCI state associated, specific or corresponding to a RS or RS resource (or vice versa) could correspond to or could be equivalent to or could be referred to/regarded as:
the RS or RS resource could correspond to a QCL source RS or RS resource e.g. a NZP CSI-RS resource or resource configuration provided or indicated in the TCI state; and/or
the RS or RS resource could correspond to a QCL root RS or RS resource e.g. a SSB quasi-co-located (QCL'ed)—e.g., of QCL-TypeD—with a RS or RS resource serving/configured as a QCL source RS e.g. a NZP CSI-RS resource or resource configuration provided or indicated in the TCI state.

In one operation mode (Mode A), a/the UE could transmit or send to the network a UE-initiated (beam) report, wherein the UE-initiated (UEI) report(s) could contain, provide, include or comprise at least a pre-notification (PN) message/trigger (or equivalently, a UEI transmission indication denoted by UEITI), and/or the (corresponding) UEI report content(s) or report quantity(s). For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could (i) request or trigger or initiate (the network/gNB to perform or conduct) transmission(s) of difference/sum beam RSs for UL (and/or DL) channel acquisition, (ii) indicate a potential transmission of the UEI report content(s)/quantity(s) associated/specific to the PN message/trigger that could comprise at least the UL channel (state) information as specified/defined herein in the present disclosure, and/or (iii) request UL resource allocation and/or indication for a second UL channel that could carry or convey the UEI report content(s)/quantity(s) comprising at least the UL channel (state) information as specified/defined herein in the present disclosure. Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-Prioritylndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger—in this case, the DCI could also be regarded/referred to as a NWR. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfiglnfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
      Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
      Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-6f: one or more CSI reporting configuration/setting IDs/indexes—for the resource(s) not used/applicable/available for the second UL channel, wherein a CSI reporting setting/configuration is provided by CSI-ReportConfig.
      Component-6g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-6h: a starting symbol/slot/etc. for the resource(s) not used/applicable/available for the second UL channel
      Component-6i: an ending symbol/slot/etc. for resource(s) not used/applicable/available for the second UL channel
      Component-6j: a time duration/length (e.g., in form/terms/number of symbols/slot/etc.), within which the resources may not be used/applicable/available for the second UL channel
      Component-6k: a number of resources not used/available/applicable for the second UL channel
      Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) comprising at least the UL channel (state) information as specified/defined herein in the present disclosure associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.

The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), a/the UE could transmit or send to the network a UEI (beam) report, wherein the UEI report(s) could contain, provide, include or comprise at least a pre-notification (PN) message/trigger (or equivalently, a UEITI), and/or the (corresponding) UEI report content(s) or report quantity(s). For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could (i) request or trigger or initiate (the network/gNB to perform or conduct) transmission(s) of difference/sum beam RSs for UL (and/or DL) channel acquisition, (ii) indicate a potential transmission of the UEI report content(s)/quantity(s) associated/specific to the PN message/trigger that could comprise at least the UL channel (state) information as specified/defined herein in the present disclosure, and/or (iii) request UL resource allocation and/or indication for a second UL channel that could carry or convey the UEI report content(s)/quantity(s) comprising at least the UL channel (state) information as specified/defined herein in the present disclosure. Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-Prioritylndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) that comprises at least the UL channel (state) information as specified/defined herein in the present disclosure associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C), a/the UE could transmit or send to the network a UEI (beam) report, wherein the UEI report(s) could contain, provide, include or comprise at least a pre-notification (PN) message/trigger (or equivalently, a UEITI), and/or the (corresponding) UEI report content(s) or report quantity(s) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could (i) request or trigger or initiate (the network/gNB to perform or conduct) transmission(s) of difference/sum beam RSs for UL (and/or DL) channel acquisition, (ii) indicate a potential transmission of the UEI report content(s)/quantity(s) associated/specific to the PN message/trigger that could comprise at least the UL channel (state) information as specified/defined herein in the present disclosure, and/or (iii) request UL resource allocation and/or indication for a second UL channel that could carry or convey the UEI report content(s)/quantity(s) comprising at least the UL channel (state) information as specified/defined herein in the present disclosure. Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-Prioritylndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger—in this case, the DCI could also be regarded/referred to as a NWR. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfiglnfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) comprising at least the UL channel (state) information as specified/defined herein in the present disclosure associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap—within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p 1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q1 (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type1 and/or Type2 is (pre-)configured by the network for transmitting or sending the UEI report content(s)/quantity(s) as defined or specified herein in the present disclosure, the UE could (always) determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

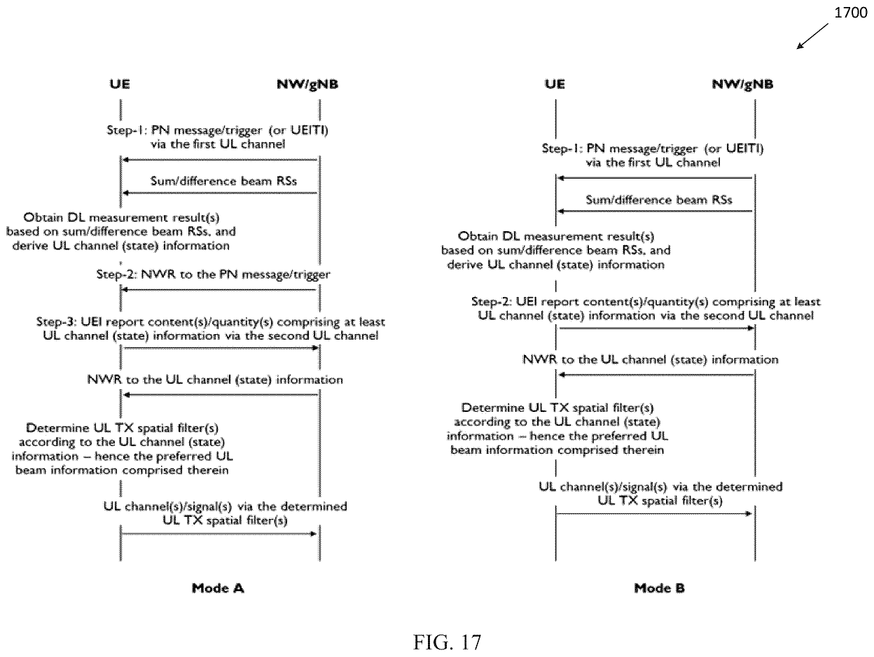

FIG. 17 illustrates an example procedure 1700n for UEI UL channel acquisition via DL sum/difference beam RSs according to embodiments of the present disclosure. The example procedure 1700 for UEI UL channel acquisition via DL sum/difference beam RSs as shown in FIG. 17 is for illustration only and other embodiments can be used without departing from the scope of the present disclosure.

According to or following those specified/defined herein in the present disclosure, after a/the UE has transmitted or sent the UEI report comprising at least the UL channel (state) information in/via/by/on/over one or more PUSCHs/PUSCH resources of the second UL channel as in Step-3 of Mode A and/or Mode C and/or Step-2 of Mode B, the UE could expect to receive from the network a NWR to the reported UL channel (state) information according to or following those specified herein in the present disclosure. Based on or according to the NWR to the reported UL channel (state) information and/or the reported UL channel (state) information itself, the UE could apply the corresponding TCI state(s)/beam(s) to set UL TX spatial filter(s) for transmitting various UL channels/signals including at least dynamic-grant and configured-grant based PUSCH and PUCCH, and for SRS applying the indicated TCI state. In FIG. 17, a conceptual example characterizing the above described design procedure(s) for UEI UL channel acquisition via DL sum/difference beams.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network in their capability signaling(s) one or more of:
Support of Mode A and therefore the corresponding operations
Support of Mode B and therefore the corresponding operations
Support of Mode C and therefore the corresponding operations

That is, a UE's capability or capability signaling could comprise one or more components each indicating support of:
{Mode A}
{Mode B}
{Mode C}
{Mode A, Mode B}
{Mode A, Mode C}
{Mode B, Mode C}

For Mode A, Mode B and/or Mode C as specified/defined herein in the present disclosure, a PN message/trigger could correspond to or could be equivalent to or could be replaced by/with or could be used in an exchangeable manner with transmission of a PN message/trigger, a PN message/trigger transmission, a PN message/trigger transmission occasion, a PUCCH resource of the first UL channel, a PN message/trigger transmission (occasion) via/in/by a PUCCH resource of the first UL channel and/or etc. throughout the present disclosure; and/or, UEI report content(s)/quantity(s) could correspond to or could be equivalent to or could be replaced by/with or could be used in an exchangeable manner with transmission of UEI report content(s)/quantity(s), UEI report content(s)/quantity(s) transmission, UEI report content(s)/quantity(s) transmission occasion, a PUSCH resource of the second UL channel, UEI report content(s)/quantity(s) transmission (occasion) via/in/by a PUSCH resource of the second UL channel and/or etc. throughout the present disclosure. For instance, UEI report content(s)/quantity(s) associated/specific to a PN message/trigger could be equivalent to a PUSCH resource of the second UL channel that carries or conveys the UEI report content(s)/quantity(s) associated/specific to a PUCCH resource of the first UL channel that carries or conveys the PN message/trigger, and/or UEI report content(s)/quantity(s) transmission occasion of a PUSCH resource of the second UL channel associated/specific to a/the PN message/trigger transmission occasion of a PUCCH resource of the first UL channel. Throughout the present disclosure, a PN message/trigger could also be referred to as a UEI transmission indication/indicator (UEITI), which could be a UCI type/parameter similar to HARQ-ACK, CSI and/or etc. Furthermore, for Mode A, Mode B and/or Mode C as specified/defined herein in the present disclosure, the UEI report content(s)/quantity(s) transmitted or sent in/via/by/on/over one or more PUSCHs/PUSCH resources of the second UL channel as in Step-3 of Mode A and/or Mode C and/or Step-2 of Mode B could correspond to or could comprise or could be equivalent to or could be in form of the UL channel (state) information as specified/defined herein in the present disclosure. All the design examples and/or procedure(s) specified or defined throughout the present disclosure can be extended or applied to two-dimensional (2D) antenna arrays/beamforming by separately considering sum/difference beams (or sum/difference beam RSs/RS resources) for/in/specific to azimuth domain/direction, and sum/difference beams (or sum/difference beam RSs/RS resources) for/in/specific to elevation domain/direction.

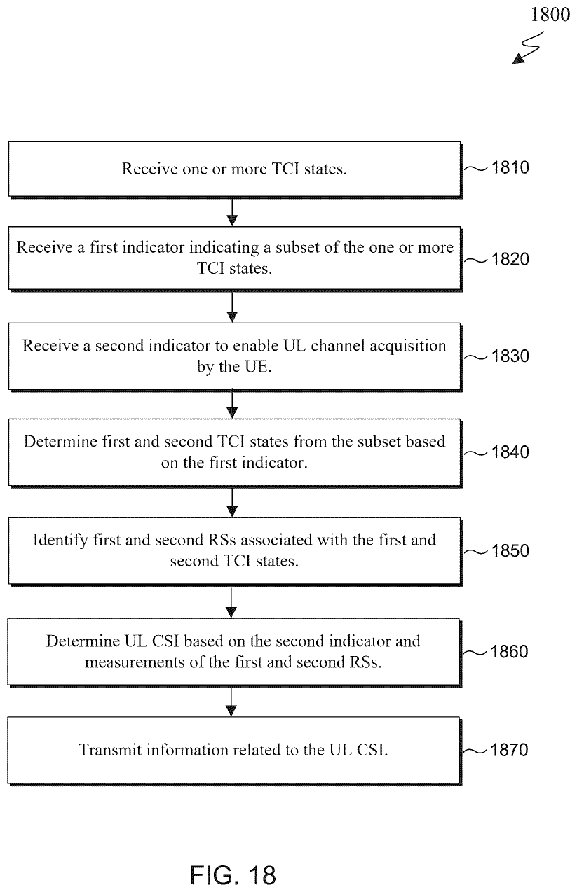

FIG. 18 illustrates an example method 1800 performed by a UE in a wireless communication system according to embodiments of the present disclosure. The method 1800 of FIG. 18 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1800 is for illustration only and other embodiments can be used without departing from the scope of the present disclosure.

The method begins with the UE receiving one or more TCI states (1810). The UE then receives a first indicator indicating a subset of the one or more TCI states (1820). In various embodiments, the first indicator is signaled via a DCI and the first indicator indicates TCI state indexes of the subset of the one or more TCI states. In various embodiments, the first indicator is a higher layer RRC parameter and the first indicator includes TCI IDs of the subset of the one or more TCI states.

The UE then receives a second indicator to enable UL channel acquisition by the UE (1830). The UE then determines first and second TCI states from the subset based on the first indicator (1840). The UE then identifies first and second RSs associated with the first and second TCI states (1850). In various embodiments, the first and second RSs are SS/PBCH blocks quasi-co-located with reference signals in the first and second TCI states, respectively, or reference signals in the first and second TCI states, respectively, and the second indicator is a higher layer RRC parameter. The UE then determines UL CSI based on the second indicator and measurements of the first and second RSs (1860).

The UE then transmits information related to the UL CSI (1870). In various embodiments, the information includes a TCI state identifier or a reference signal identifier for setting a spatial domain transmit filter. In various embodiments, the UE receives a third indicator in response to transmission of the information and determines a spatial domain transmit filter based on the third indicator. In various embodiments, the UE receives a configuration including a time duration (T_{offset}), and reception of the third indicator is within T_{offset} from an end of transmission of the information.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive one or more transmission configuration indication (TCI) states;
receive a first indicator indicating a subset of the one or more TCI states; and
receive a second indicator to enable uplink (UL) channel acquisition by the UE; and
a processor operably coupled with the transceiver, the processor configured to:
determine, based on the first indicator, a first TCI state and a second TCI state from the subset;
identify a first reference signal (RS) and a second RS associated with the first and second TCI states, respectively; and
determine, based on the second indicator and measurements of the first and second RSs, UL channel state information (CSI),
wherein the transceiver is further configured to transmit information related to the UL CSI.

2. The UE of claim 1, wherein:
the first indicator is signaled via a downlink control information (DCI); and
the first indicator indicates TCI state indexes of the subset of the one or more TCI states.

3. The UE of claim 1, wherein:
the first indicator is a higher layer radio resource control (RRC) parameter; and
the first indicator includes TCI state identities (IDs) of the subset of the one or more TCI states.

4. The UE of claim 1, wherein:
the first and second RSs are:
synchronization signal/physical broadcast channel (SS/PBCH) blocks quasi-co-located with reference signals in the first and second TCI states, respectively, or
reference signals in the first and second TCI states, respectively; and
the second indicator is a higher layer radio resource control (RRC) parameter.

5. The UE of claim 1, wherein the information includes a TCI state identifier or a reference signal identifier for setting a spatial domain transmit filter.

6. The UE of claim 1, wherein:
the transceiver is further configured to receive a third indicator in response to transmission of the information; and
the processor is further configured to determine a spatial domain transmit filter based on the third indicator.

7. The UE of claim 6, wherein:
the transceiver is further configured to receive a configuration including a time duration (T_{offset}), and
reception of the third indicator is within the T_{offset} from an end of transmission of the information.

8. A base station (BS), comprising:
a processor; and
a transceiver operably coupled with the processor, the transceiver configured to:
transmit one or more transmission configuration indication (TCI) states;
transmit a first indicator indicating a subset of the one or more TCI states;
transmit a second indicator to enable uplink (UL) channel acquisition by the UE; and
receive information related to a UL channel state information (CSI),
wherein the UL CSI is based on the second indicator, a first reference signal (RS), and a second RS, and
wherein the first and second RSs are associated with a first TCI state and a second TCI state from the subset.

9. The BS of claim 8, wherein:
the first indicator is signaled via a downlink control information (DCI); and
the first indicator indicates TCI state indexes of the subset of the one or more TCI states.

10. The BS of claim 8, wherein:
the first indicator is a higher layer radio resource control (RRC) parameter; and
the first indicator includes TCI state identities (IDs) of the subset of the one or more TCI states.

11. The BS of claim 8, wherein:
the first and second RSs are:
synchronization signal/physical broadcast channel (SS/PBCH) blocks quasi-co-located with reference signals in the first and second TCI states, respectively, or
reference signals in the first and second TCI states, respectively; and
the second indicator is a higher layer radio resource control (RRC) parameter.

12. The BS of claim 8, wherein the information includes a TCI state identifier or a reference signal identifier for setting a spatial domain transmit filter.

13. The BS of claim 8, wherein:
the transceiver is further configured to transmit a third indicator in response to reception of the information; and
a spatial domain transmit filter is based on the third indicator.

14. The BS of claim 13, wherein:
the transceiver is further configured to transmit a configuration including a time duration (T_{offset}), and
transmission of the third indicator is within the T_{offset} from an end of reception of the information.

15. A method performed by a user equipment (UE), the method comprising:
receiving one or more transmission configuration indication (TCI) states;
receiving a first indicator indicating a subset of the one or more TCI states;
receiving a second indicator to enable uplink (UL) channel acquisition by the UE;
determining, based on the first indicator, a first TCI state and a second TCI state from the subset;
identifying a first reference signal (RS) and a second RS associated with the first and second TCI states, respectively;
determining, based on the second indicator and measurements of the first and second RSs, UL channel state information (CSI); and
transmitting information related to the UL CSI.

16. The method of claim 15, wherein:
the first indicator is signaled via a downlink control information (DCI); and
the first indicator indicates TCI state indexes of the subset of the one or more TCI states.

17. The method of claim 15, wherein:
the first indicator is a higher layer radio resource control (RRC) parameter; and
the first indicator includes TCI state identities (IDs) of the subset of the one or more TCI states.

18. The method of claim 15, wherein:
the first and second RSs are:
synchronization signal/physical broadcast channel (SS/PBCH) blocks quasi-co-located with reference signals in the first and second TCI states, respectively, or
reference signals in the first and second TCI states, respectively; and
the second indicator is a higher layer radio resource control (RRC) parameter.

19. The method of claim 15, wherein the information includes a TCI state identifier or a reference signal identifier for setting a spatial domain transmit filter.

20. The method of claim 15, wherein:
receive a third indicator in response to transmission of the information; and
determine a spatial domain transmit filter based on the third indicator.
